(19) United States
(12) Patent Application Publication
(10) Pub. No.: US 2025/0326516 A1
(43) Pub. Date: Oct. 23, 2025

(54) MACHINES, SYSTEMS, AND METHODS FOR IDENTIFYING AND REMOVINGLABELS FROM A WEB

(71) Applicant: EMTRO LLC dba EMTInternational, Inc., Hobart, WI (US)

(72) Inventors: Jacob Russell Liimatta, De Pere, WI (US); David Jon Hintz, Suamico, WI (US)

(73) Assignee: EMTRO LLC d/b/a EMT International, Hobart, WI (US)

(21) Appl. No.: 19/182,965

(22) Filed: Apr. 18, 2025

Related U.S. Application Data
(60) Provisional application No. 63/636,421, filed on Apr. 19, 2024.
(60) Provisional application No. 63/692,958, filed on Sep. 10, 2024.

(51) Int. Cl. B65C 9/30; B25J 9/16; B25J 11/00; B25J 15/06; B65C 9/18

(52) U.S. Cl. CPC B65C 9/30; B25J 9/1679; B25J 11/005; B25J 15/0616; B65C 9/18

(57) ABSTRACT

A machine for removing a defective label from a first web with a good-quality label thereon includes a roller configured to convey the first web and a robot configured to remove the defective label from the first web.

### CROSS-REFERENCE TO RELATED APPLICATION

The present disclosure is based on and claims priority to U.S. Provisional Patent Application No. 63/636,421 filed Apr. 19, 2024, and U.S. Provisional Patent Application No. 63/692,958 filed Sep. 10, 2024, the disclosures of which are incorporated herein by reference.

### FIELD

The present disclosure relates to machines utilized in the printing industry to process a web of material, and specifically to machines that identify and remove labels from a web.

### BACKGROUND

The following U.S. Patents and U.S. Patent Application Publications are incorporated herein by reference in entirety.

U.S. Pat. No. 3,733,230 discloses a processing device having an unwinding mandrel and a rewinding mandrel, that is adapted to receive rolls of web on the former and rewind the web on the latter. Between the mandrels, the unwinding web is made to follow a path that brings it sequentially to a web inspection location and a splicing location. Braking means are provided for halting the movement of the web along the path.

U.S. Pat. No. 5,474,248 discloses a slitter/rewinder machine for processing web material such as label stock into a plurality of narrower widths. The web from a feed roll is pulled through the machine by the powered rewind arbor shafts. The machine includes various processing stations including an inspection station, a splice table, a web guide, a web clamp, and a slitter station.

U.S. Patent Application Publication No. 2007/0187020 discloses a web processing machine that permits inspection and repair of a roll of web material. The machine includes an inspection zone vertically juxtaposed to a splicing zone. The inspection zone is structured to be removed from the juxtaposed position to a retracted position where the splicing zone is exposed permitting an operator to perform a modification of the web without having to substantially move from the position where the operator was located to perform inspection while the machine is running.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a machine for removing a defective label from a first web with a good-quality label thereon includes a roller configured to convey the first web and a robot configured to remove the defective label from the first web.

In certain examples, a machine for placing a good-quality label from a first web in a location in which a defective label was located includes a roller configured to convey the first web and a robot configured to dispense the good-quality label onto the first web in the location the defective label is removed from the first web.

In certain examples, a machine for removing a defective label from a first web a good-quality label thereon includes a first roller configured to convey the first web, a label removal system configured to remove the defective label from the first web, and a second roller configured to convey a second web such that the second web receives the good-quality label from the first web.

In certain examples, a method of operating a machine that removes a defective label from a first web includes identifying a defective label on the first web, removing, with a robot, the defective label from the first web, and replacing a good-quality label onto the first web in a location the defective label is removed.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a schematic diagram of an example machine according to the present disclosure.

FIG. 2 is a schematic diagram of an example control system according to the present disclosure.

FIG. 3 is a schematic diagram of an example defect reject section of an example machine of the present disclosure.

FIG. 4 is a schematic diagram of an example label advance section of an example machine of the present disclosure.

FIG. 5 is a schematic diagram of an example section of web with groupings of good-quality labels separated by gaps on the web.

FIG. 6 is a schematic diagram of an example section of the web with the good-quality labels continuously spaced along the section of the web.

FIGS. 7-13 are schematic diagrams of portions of other example machines according to the present disclosure.

FIG. 14A and 14B are schematic views of an example defect reject section according to the present disclosure.

FIG. 15 is a schematic view of another example defect reject section according to the present disclosure.

FIG. 16 is a schematic view of another example defect reject section according to the present disclosure.

FIG. 17 is a schematic view of another example defect reject section according to the present disclosure.

FIG. 18 is a schematic view of another example defect reject section according to the present disclosure.

FIGS. 19-20 are perspective views of an example gripping member according to the present disclosure.

FIG. 21 is a cross-sectional view of the gripping member of FIGS. 1-20.

FIG. 22 is an example method according to the present disclosure.

FIGS. 23-25 is a schematic view of an example gripping member according to the present disclosure in different positions relative to a web.

FIG. 26 is a schematic view of another example machine according to the present disclosure.

FIG. 27 is a schematic view of another example machine according to the present disclosure.

FIG. 28 is a schematic view of another example machine according to the present disclosure.

FIG. 29 is a schematic view of another example machine according to the present disclosure.

### DETAILED DESCRIPTION

In the graphics industry, labels are laminated to webs and the webs are wound into rolls that can be easily transported to machines for further processing and/or final application of the labels to products or other intended uses. Prior to final application of the labels, the labels may be advantageously processed by a machine that detects damaged or defective labels. Damaged or defective labels arise during printing and/or finishing processes, and thus removal of the defective labels from the web provides a more consistent product to a customer.

A “finished roll” of labels is one that has been printed, processed, and/or slit so the labels are ready for application. It is often desired that a finished roll contain only labels that have good-quality (e.g., correctly printed labels or correctly oriented labels), and it is common to use conventional machines to detect poor quality, or defective labels so that they can be manually removed from the roll. After removed, the roll is then spliced back together. These conventional quality control machines are offline processes-rolls that have been printed and processed are taken to the quality control machine for inspection. This offline manual process is tolerated because it is often preferable to allow the printing press and finishing processes to run continuously, rather than constantly interrupt to correct or remove defective labels.

In one example, a conventional inspection slitter rewinder machine is utilized to remove the defective labels. During operation of these conventional machines, a roll of labels is loaded onto an unwind cylinder and the roll of labels is unwound by drive rollers. The web is conveyed through an inspection device that visually inspects, with a camera or sensor, to identify defective labels on the web. When defective labels are identified, the conventional machine decelerates the web such that the defective labels are positioned at a splice table. The operator then manually cuts the web and then advances the web until all the defective labels are clear. The web is cut a second time at the end of the defective labels such that the portion of web with the defective labels thereon are removed and disposed of. The operator then splices the cut ends of the web together with an adhesive, such as single-sided adhesive tape. The conventional inspection slitter rewinder machine can then be restarted and the inspection process resumes until the entire roll of labels is inspected. As such, the conventional machine produces a rewound roll of labels that is free of defective labels. In other examples, the features of the above-described conventional inspection slitter rewinder machine are incorporated into a conventional processing line machine that includes upstream processes related to flexographic printing and die cutting of the labels. Other examples of conventional machines that process, inspect, and/or remove labels are disclosed in the above-incorporated U.S. Patents and U.S. Patent Application Publication.

The present inventors recognized several disadvantages associated with conventional inspection slitter rewinder machines and conventional processing line machines such as large work-in-progress inventory, greater risk of handling damage, numerous process steps, and increased lead time of customer orders. Further, the present inventors have recognized that errors can occur in the manual splicing process that may cause the web to be misaligned. The misaligned web can lead to tracking problems downstream of the splice table, place increased stress on the web possibly leading to the web breaking, and/or machine jams that may damage the machine, the web, and/or the labels. Furthermore, the present inventors recognized that the manual splicing process is time-consuming and can cause machine shutdowns.

Accordingly, the present inventors endeavored to make new and improved example machines of the present disclosure minimize or eliminate splices in a roll of labels and/or minimize or eliminate machine shutdowns. Furthermore, the present inventors have endeavored to develop example machines that provide real-time feedback regarding print and/or finish defects inline with the printing machines. Through research and development, the present inventors developed the example machines, apparatuses, systems, and methods of the present disclosure described hereinbelow.

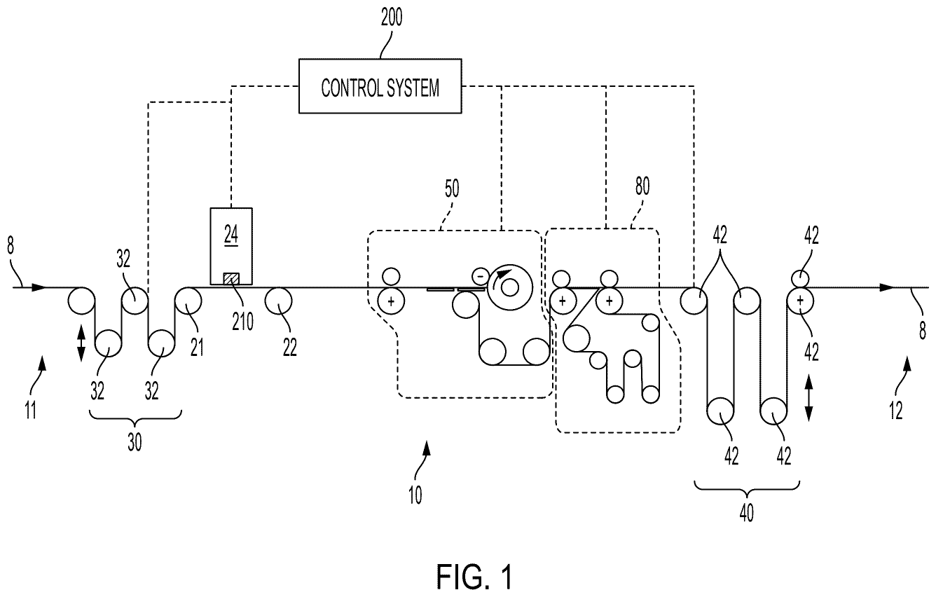

FIG. 1 depicts a schematic drawing of an example label processing machine 10 of the present disclosure. The machine 10 has an upstream end 11 that receives a web 8 with labels (not shown) laminated thereon from an upstream web label processing machine (not shown), such as a flexographic printing and die-cutting machine. In certain examples, the label includes a communication component such as an RFID component. In other examples, the web 8 is received from a wound roll of labels supported by an upstream machine (not shown). As will be described in greater detail herein below, the web 8 is conveyed through machine 10 with a conveyor system (e.g., drive and driven rollers, tension rollers, upstream or downstream machines, and/or the like and the machine 10 is configured to automatically inspects the labels on the web and further remove defective labels without cutting or splicing the web 8 each time the defective labels are removed. Accordingly, the web 8 is dispensed from a downstream end 12 with only good-quality labels and without defective labels. The web 8 and the good-quality labels thereon are then further conveyed to another downstream machine (not shown) for further processing (e.g., a turret rewinder may rewind the web 8 to form a finished roll having the good-quality labels).

Now turning to FIG. 1 to describe the process and the machine 10 in greater detail, the web 8 is received at the upstream end 11 and is conveyed through a first accumulator section 30 (described herein) to a first inspection roller 21 and a second inspection roller 22. The inspection rollers 21, 22 are spaced apart from each other such that the web 8 extends between the inspection rollers 21, 22 and the labels on the web 8 are inspected by an inspection system 24. The inspection system 24 is connected to a control system 200 and includes a camera or detector 210 that detects defective labels on the web 8. The length of web 8 between the second inspection roller 22 and the defect reject section 50 (described herein) remains constant. Example inspection camera that can be utilized with the inspection system 24 is commercially available from ATV, Inc.

The machine 10 includes multiple downstream sections such as a defect reject section 50, a label advance section 80, and a second accumulator section 40. These sections, including the components and features thereof, are described hereinbelow.

The web 8 is conveyed through the first accumulator section 30 that includes a series of movable rollers 32. During operation of the machine 10, the rollers 32 move relative to each other to compensate for changes in the movement/speed of the web 8 that varies from consistent or normal operating movement/speed of the web 8. That is, the rollers 32 in the first accumulator section 30 move relative to each other to thereby adjust the amount or length of the web 8 gathered in the first accumulator section 30 and account for variances in movement/speed of the web 8. For example, if the web speed in the defect reject section 50 and the label advance section 80 is different than the normal operating speed of the web 8, the first accumulator section 30 takes up the difference (an amount of the web 8). The first accumulator section 30 accounts for movement/speed variations of the web 8 that occur upstream of the first accumulator section 30 based on output (e.g., signals, data) from sensors (not shown) that monitor the speed/movement of the web 8. The sensors are connected to the control system 200, and the control system 200 controls movement of the rollers 32 in the first accumulator section 30. Accordingly, the first accumulator section 30 prevents problems from occurring in downstream sections of the machine 10 that may occur if the web 8 dispenses from the first accumulator section 30 with inconsistent movement/speed.

A second accumulator section 40 is similar to the first accumulator section 30 and placed downstream of the first accumulator section 30. The second accumulator section 40 is positioned downstream of the label advance section 80 (described hereinbelow) and receives the web 8 from the label advance section 80. The second accumulator section 40 also has a series of movable rollers 42. During operation of the machine 10, the rollers 42 move relative to each other to compensate for changes in the movement/speed of the web 8 that may vary from consistent normal operating movement/speed of the web 8. Similar to the rollers 32 of the first accumulator section 30, the rollers 42 in the second accumulator section 40 move relative to each other to thereby account for variances in movement/speed of the web 8. For example, the rollers 42 in the second accumulator section 40 move relative to each other to adjust the amount of the web 8 contained in the second accumulator section 40. Thus, the rollers 42 move to “take up” or “let out” a length or amount of web 8 such that the web 8 conveyed from the second accumulator section 40 is conveyed at the normal operating speed of the web 8. The second accumulator section 40 accounts for movement/speed variations of the web 8 that occur downstream of the second accumulator section 40 based on output (e.g., signals, data) from sensors positioned along the machine 10. The first and second accumulator section 30, 40 cooperate with each other and communicate with the control system 200 such the machine 10 efficiently and effectively operates.

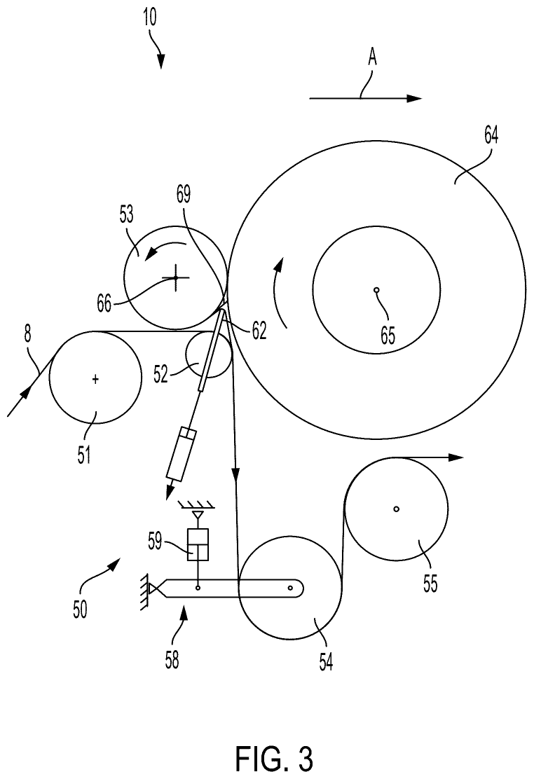

The defect reject section 50 is positioned between the accumulator sections 30, 40, and FIG. 3 depicts an example defect reject section 50 in greater detail. The defect reject section 50 is configured to remove defective labels from the web 8 that are identified as defective by the inspection system 24. In operation, the web 8, having both correctly printed labels and defective labels laminated thereon, is conveyed into the defect reject section 50 from the second inspection roller 22. The defect reject section 50 then removes the defective labels as the web 8 is conveyed through the defect reject section 50 driving and/or driven rollers. Thus, the web 8 is conveyed out of the defect reject section 50 with only good-quality labels laminated thereon. The web 8 conveyed out of the defect reject section 50 has spaces or gaps thereon where the defective labels were removed. Operation of the defect reject section 50 is described in greater detail below.

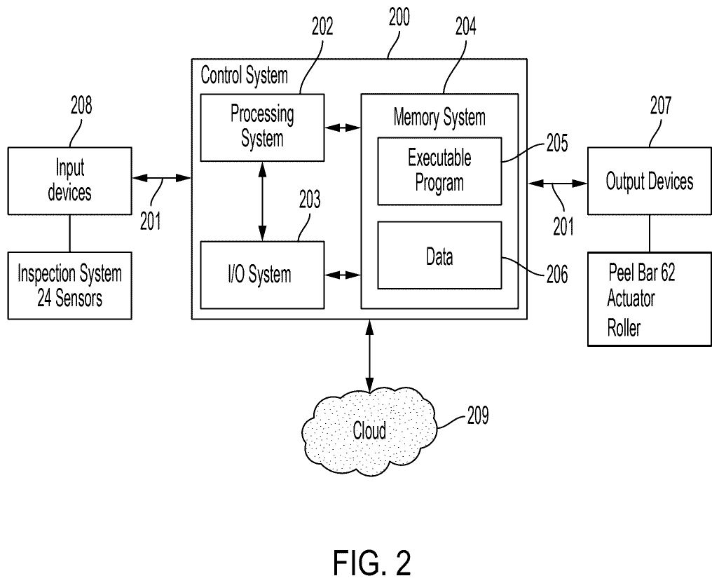

FIG. 2 depicts an example control system 200 according to the present disclosure. The control system 200 is configured to control various components of the machine 10 and/or receives data from the components and/or sensors of the machine 10. In certain examples, the control system 200 receives data from rotational sensors on the rollers, top-of-form or registration sensors along the machine 10, encoders on the web 8, RFIDs in the web 8, and/or the like. The control system 200 has a processing system 202 that processes the data such that the control system 200 can determine which sections of the web 8 have good-quality labels thereon, defective labels thereon, which labels are good-quality or bad-quality, gaps on the web 8, and/or the like. In certain examples, the control system 200 is capable of determining the condition of the web 8 and/or the labels thereon and accurately tracking the web 8 and the labels at all points in the machine 10. Thus, the control system 200 can accurately and precisely control different components of the machine 10 to remove the defective labels. In certain examples, the control system 200 tracks the location of individual labels throughout the machine 10.

Certain aspects of the present disclosure are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processors or other control devices. The connections between functional and logical block components are merely exemplary, which may be direct or indirect, and may follow alternate pathways.

In certain examples, the control system 200 communicates with each of the one or more components of the machine 10 via a communication link 201, which can be any wired or wireless link. The control system 200 is capable of receiving information and/or controlling one or more operational characteristics of the machine 10 and its various sub-systems by sending and receiving control signals via the communication links 201. In one example, the communication link 201 is a controller area network (CAN) bus; however, other types of links could be used. It will be recognized that the extent of connections and the communication links 201 may in fact be one or more shared connections, or links, among some or all of the components in the machine 10. Moreover, the communication link 201 lines are meant only to demonstrate that the various control elements are capable of communicating with one another, and do not represent actual wiring connections between the various elements, nor do they represent the only paths of communication between the elements. Additionally, the machine 10 may incorporate various types of communication devices and systems, and thus the illustrated communication links 201 may in fact represent various different types of wireless and/or wired data communication systems.

The control system 200 may be a computing system that includes the processing system 202, a memory system 204, and an input/output (I/O) system 203 for communicating with other devices, such as input devices 208 (e.g., inspection system 24) and output devices 107 (e.g., actuator for peel bar 62), either of which may also or alternatively be stored in a cloud 209. The processing system 202 loads and executes an executable program 205 from the memory system 204, accesses data 206 stored within the memory system 204, and directs the machine 10 to operate as described in further detail below.

The processing system 202 may be implemented as a single microprocessor or other circuitry, or be distributed across multiple processing devices or sub-systems that cooperate to execute the executable program 205 from the memory system 204. Non-limiting examples of the processing system include general purpose central processing units, application specific processors, and logic devices.

The memory system 204 may comprise any storage media readable by the processing system 202 and capable of storing the executable program 205 and/or data 206. The memory system 204 may be implemented as a single storage device, or be distributed across multiple storage devices or sub-systems that cooperate to store computer readable instructions, data structures, program modules, or other data. The memory system 204 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

Turning back to FIG. 3, another example defect reject section 50 according to the present disclosure is depicted. The web 8 is received into the defect reject section 50 and conveyed between and along a series of rollers, namely a first reject deadbar or roller 51, a second reject roller 52, a third reject roller 53, a fourth reject roller 54, and a fifth reject roller 55, the convey the web 8. The first reject roller 51 rotates with the web 8 and directs the web 8 toward the second reject roller 52 and the third reject roller 53. In the example depicted in FIG. 3, the second reject roller 52 is a stationary dead bar made with a wear-resistant material or low-friction material. For example, the second reject roller 52 is made with polished chrome. In other examples, the second reject roller 52 is an air-bar or other air directing apparatus. The web 8 is conveyed around the second reject roller 52 to the fourth reject roller 54 which is connected to a dancer assembly 58 that maintains tension on the web 8. In certain examples, the dancer assembly 58 has an actuator or a spring 59 that dampens the movement of the fourth reject roller 54 that is pivotally connected to a fixed frame. The web 8 is further conveyed around the fourth reject roller 54, past the fifth reject roller 55, and downstream to the label advance section 80.

As the web 8 is conveyed along and around the second reject roller 52, the good-quality labels are conveyed with the web 8 toward the fourth reject roller 54. Note that the second reject roller 52 has a large first radius such that as the web 8 is conveyed along the second reject roller 52 the labels do not delaminate from the web 8. Conveyance of the web 8 with the good-quality labels continues until a defective label approaches the second reject roller 52. That is, if the inspection system 24 (FIG. 1) does not detect defective labels on the web 8, the web 8 with the good-quality labels thereon simply conveys through the defect reject section 50 to the label advance section 80.

However, if the inspection system 24 detects one or more defective labels on the web 8, the control system 200 controls one or more components of the defect reject section 50 to remove the defective labels without stopping the web 8. Specifically, as the defective labels approach the second reject roller 52, the control system 200 controls a peel bar 62 to move in a direction toward the web 8 and into an extended position such that the web 8 is moved away from the second reject roller 52. The peel bar 62 defines a small second radius that is smaller than the first radius of the second roller 52, and thus, as the web 8 is conveyed around the peel bar 62, the defective label(s) delaminate from the web 8 and extend away from the web 8 (see label 69 on FIG. 3). In certain, examples, the second reject roller 52 has a lengthwise slot (not shown) through which the peel bar 62 extends to contact and move the web 8. In this example, the peel bar 62 is an elongated plate.

As the defective labels delaminate and/or extend from the web 8, the defective labels contact and stick to a waste rewind core shaft 64 that is rotating about an axis 65. Accordingly, the defective labels adhere to the outer circumference of the waste rewind core shaft 64 and are thus removed from the web 8. The waste rewind core shaft 64 is rotated in a direction toward the defective labels (e.g., clockwise) such that the defective labels are wrapped along the outer circumference. The defective labels layer on top of each other as the waste rewind core shaft 64 is rotated such that the position of the outer circumference of the waste rewind core shaft 64 changes. The waste rewind core shaft 64 is configured to translate away from (see arrow A) the third reject roller 53 to accommodate the layering of the defective labels thereon. In certain examples, the waste rewind core shaft 64 is biased, by an actuator (not shown; e.g., pneumatic cylinder), toward the third reject roller 53 to thereby maintain a constant pressure between the third reject roller 53 and the waste rewind core shaft 64. Note that the third reject roller 53 acts as a drive wheel that rotates the waste rewind core shaft 64. The third reject roller 53 is rotated by a motor (not shown) about an axis 66 in a direction toward the waste rewind core shaft 64 (e.g., counterclockwise direction).

After the defective labels are removed from the web 2, the control system 200 controls the peel bar 62 to move in a direction away from the web 8 into a retracted position (not shown) such that the web 8 and good-quality labels on the web 8 again convey along the second reject roller 52 toward the fourth reject roller 54. Note that the dancer assembly 58 permits the fourth reject roller 54 to pivot toward or away from the second reject roller 52 as the peel bar 62 moves into and between the extended and retracted positions.

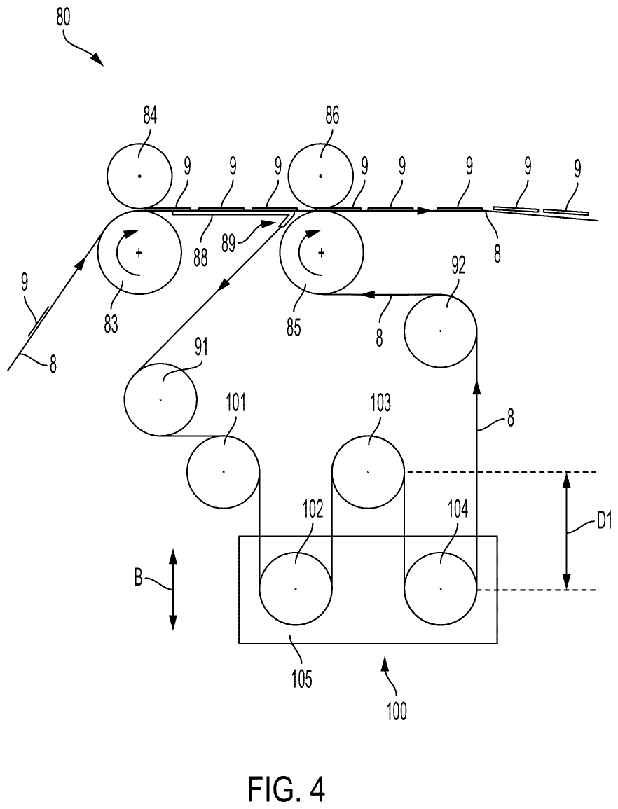

The web 8 with the good-quality labels thereon is conveyed from the defect reject section 50 to the label advance section 80 (see FIG. 1). An example label advance section 80 is depicted in greater detail in FIG. 4. The label advance section 80 is for advancing good-quality labels ahead on the web 8 from an upstream section of the web 8 to a downstream section of the web 8 such that the web 8 carries continuous rows of good-quality labels laminated thereon without gaps or spacing between the good-quality labels.

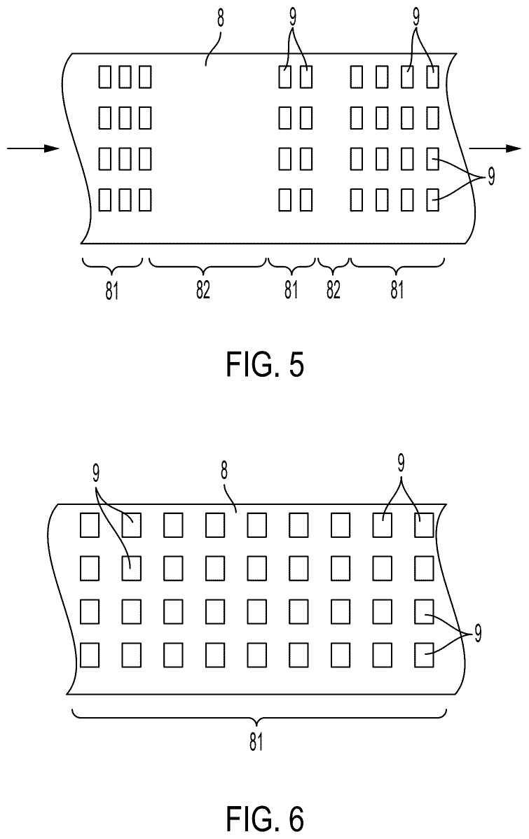

FIG. 5 depicts an example upstream section of the web 8 received into the label advance section 80. In this example, the upstream section of the web 8 may have good-quality labels 81 (individual labels 9) or grouping of good-quality labels 81 separated by spaces or gaps 82 on the web 8 where the defective labels were originally laminated to the web 8 but were removed by the defect reject section 50 (as described above). The present inventors recognized that it is advantageous to “remove” these gaps 82 of the web 8 by “filling” the gaps 82 with good-quality labels such that the web 8 dispenses with the good-quality labels continuously along the web 8, as shown in FIG. 5. To “fill” the gaps 82, the label advance section 80 delaminates the good-quality labels from upstream section of the web 8 and re-laminates the good-quality labels onto a different downstream section of the web 8. Thus, there are no spaces or gaps on the web 8 and the good-quality labels are continuous along the web 8 (as depicted in FIG. 6).

An example operational sequence of the label advance section 80 is described hereinbelow with reference to FIG. 4. The web 8 is received by and conveyed through a first set of nip rollers, namely a first nip roller 83 and a second nip roller 84. The first nip roller 83 is rotated in a downstream direction (e.g., clockwise direction) by a motor (not shown) such that the second nip roller 84 rotates in the opposite direction (e.g., counterclockwise direction). The web 8 and the labels 9 are conveyed downstream along and around a static peel bar 88 to a first advance roller 91. The web 8 is further conveyed downstream through a dynamic accumulator 100, around a second advance roller 92, and between a third nip roller 85 and a fourth nip roller 86. The third nip roller 85 is rotated (e.g., clockwise direction) by a motor (not shown) to convey the web 8 and rotate the fourth nip roller 86 in the opposite direction (e.g., counterclockwise direction). Note that a length of the web 8 is between the first advance roller 91 and the third and fourth nip rollers 85, 86.

As the web 8 is conveyed along the peel bar 88, the web 8 conveys around a sharp turn or angle 89 of the peel bar 88 such that the good-quality labels 9 on the web delaminate from the web 8 and extend from the web 8 toward the third and fourth nip rollers 85, 86. The third and fourth nip rollers 85, 86 re-laminate the good-quality labels 9 to the downstream section of the web 8 at these nip rollers 85, 86. Thus, the good-quality labels 9 are transferred from an upstream section of the web 8 to different, downstream section of the web 8. Note that the length of web 8 between the first advance roller 91 and the third and fourth nip rollers 85, 86 do not have labels thereon.

The operation of delaminating and re-laminating the good-quality labels 9 described above continuously occurs as long as there are no gaps on the web 8. In the event that the control system 200 determines (based on outputs (e.g., signals, data) from the sensors) that a gap on the web 8 is approaching the peel bar 88, the control system 200 stops rotation of the third nip roller 85 such that the web 8 is not conveyed past the nip rollers 85, 86. At the same time, the dynamic accumulator 100 moves to “take up” the gap on the web 8. Thus, the length of the web 8 between the first advance roller 91 and the third and fourth nip rollers 85, 86 increases each time the dynamic accumulator 100 “takes up” a gap on the web 8 (a length of the web 8).

The example dynamic accumulator 100 depicted in FIG. 4 includes a first accumulator roller 101, a second accumulator roller 102, a third accumulator roller 103, and a fourth accumulator roller 104. The second and fourth accumulator rollers 102, 104 are rotatably coupled to a frame 105 that moves relative to the first and third accumulator rollers 101, 103 (see direction arrow B). In operation, the second and fourth accumulator rollers 102, 104 downwardly move away from the first and third accumulator rollers 101, 103 (e.g., distance D1 increases) to thereby “take up” the gaps on the web 8 while the third nip roller 85 is stopped. The frame 105 can be moved by any suitable drive system or component, such as servomotors in rotational-to-linear motion with a belt drive and linear actuators with lead screws.

Once the gap on the web 8 passes the peel bar 88 and the good-quality labels approach the peel bar 88, the control system 200 restarts rotation of the third nip roller 85 and the dynamic accumulator 100 stops moving. Thus, as described above, the good-quality labels are delaminated from the upstream section of the web 8 and re-laminate to the downstream section of the web 8 and the third nip roller 85 conveys the web 8 with good labels thereon downstream. Note that while the good-quality labels are being transferred, the frame 105 remains stationary and the web 8 without labels thereon conveys through the dynamic accumulator 100 and to the nip rollers 85, 86.

The operation of starting/stopping the third nip roller 85 and moving the frame 105 to thereby “take up” the gaps on the web 8 can occur multiple times as the web 8 is processed by the label advance section 80. A person of ordinary skill in the art will recognize that as multiple gaps on the web 8 are “taken up” by the dynamic accumulator 100, the distance D1 between the first and third accumulator rollers 101, 103 and the second and fourth accumulator rollers 102, 104 increases. Once distance D1 is at a maximum distance, the dynamic accumulator 100 can no longer “take up” additional gaps on the web 8. Thus, the dynamic accumulator 100 must dispense or expel the excess length of web 8. To expel the excess length of web 8 from the dynamic accumulator 100, the control system 200 stops rotation of the first nip roller 83 and the frame 105 moves toward the first and third accumulator roller 101, 103. At the same time, the third nip roller 85 conveys the web 8 out of the label advance section 80. Note that after the excess length of the web 8 is expelled, the frame 105 is in a position such that the distance D1 is at a minimum distance. Once the frame 105 is in this position, the label advance section 80 is “reset” and the label advance section 80 can resume normal operation, as described above. In certain examples, the expelled length of the web 8 is cut from the web 8 by another machine. In certain examples, the expelled length of the web 8 is cut into sheets. In other examples, the expelled length of the web 8 is wound onto a turret roller (not shown). In certain examples, the dynamic accumulator 100 is large enough to “take up” all the gaps on the web 8 such that the excess length of web in the dynamic accumulator 100 only needs to be expelled after a complete finished roll of labels is processed. In certain examples, a sheeter (not shown) is included to sheet the web 8 with finished labels thereon.

The web 8 with the good-quality labels laminated thereon dispenses to the second accumulator section 40, described above, and is further conveyed from the downstream end 12 of the machine 10 (see FIG. 1) for further processing (e.g., other downstream machines perform operations on the web 8, the web 8 is manually packaged).

In certain examples, the machine 10 includes or is connected to a turret rewinder (not shown) at the downstream end 12 to thereby collect or dispose of the web 8 expelled from the dynamic accumulator 100. In this example, as the last good-quality label on the web 8 approaches the turret rewinder, the turret rewinder cuts the web 8 and finishes that roll of labels. Instead of immediately starting the next roll of labels, the waste liner is sheeted and rejected into a waste receptacle. When the next good-quality label reaches the turret rewinder, it starts the next finished roll. In other examples, the expelled web is wound onto either the end of a roll of labels or the start of the next roll of labels.

The machine 10 may be used with any type of machine such as an automatic turret rewinder. The turret rewinder would use a knife device, such as a rotary shear knife (flying knife), and have an integrated sheet reject gate. Thus, the rotary shear knife is able to work in conjunction with the machine 10 to remove the excess web from the dynamic accumulator 100. In certain examples, the machine 10 would allow the excess web to pay out of the dynamic accumulator 100 between rolls. When the blank liner reaches the rotary shear knife, the first cut completes the roll, and some number of following cuts are used to cut the blank liner into sheets, which are rejected into a bin. The final cut on the blank liner prepares the leading edge of the web, containing quality labels, to start the next roll. In certain examples, the turret rewinder is excluded and the knife device is used with the integrated reject gate.

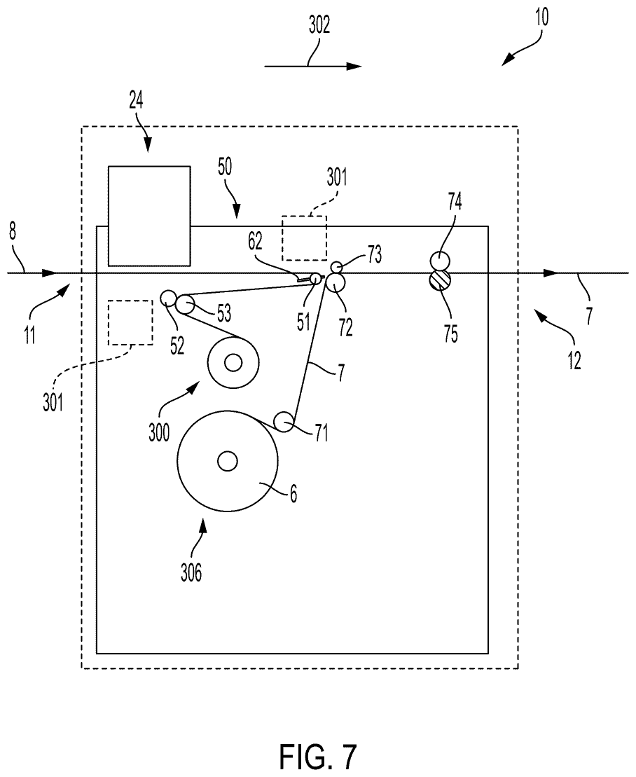

Turning now to FIGS. 7-17, other example machines 10 and/or example defect reject sections 50 according to the present disclosure are depicted.

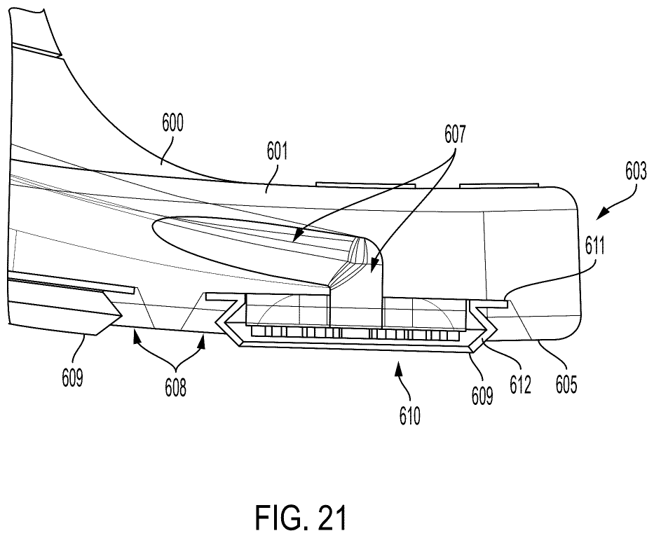

The example machines 10 and/or the example defect reject sections 50 depicted in FIGS. 7-29 can include one or more features and/or components described with reference to the example machines 10 and/or the example defect reject sections 50 described and depicted above with respect to FIGS. 1-6. Similarly, the example machines 10 and/or the example defect reject sections 50 described and depicted with reference to FIGS. 1-6 can include any features and/or components of the example machines 10 and/or the example defect reject sections 50 described herein below with reference to FIGS. 7-29. Note that features and/or components of the example machines 10 and/or the example defect reject sections 50 described with reference to FIGS. 7-29 that are similar to the components of the example machines 10 and/or the example defect reject sections 50 described with reference to FIGS. 1-6 are denoted with the same part numbers, however, it should be understood that the use of the same part numbers for features and/or components of the present disclosure should not be construed to indicate that the similarly marked features and/or components are necessarily identical. Instead, the similarly marked features and/or components may have varying features or characteristics. For instance, the length in a machine direction of the defect reject section 50 depicted in FIG. 3 is different than the length in the machine direction of the defect reject section 50 depicted in FIG. 7.

FIG. 7 depicts another example machine 10 according to the present disclosure. The machine 10 receives the web 8 with the good-quality labels and the defective labels thereon via the upstream end 11. The web 8 and labels are scanned by the inspection system 24 and conveyed to the example defect reject section 50.

The defect reject section 50 is configured to remove defective labels from the web 8 that are identified as defective by the inspection system 24. The web 8 is conveyed between and/or along a series of rollers, namely a first reject roller or deadbar 51, a second reject roller 52, and a third reject roller 55. One or more of the reject rollers 51-53 are driven rollers.

As the web 8 is conveyed along and around the first reject deadbar 51, a peel bar 62 is actuated by an actuator (not depicted) into the extended position (not depicted in FIG. 7). The peel bar 62 defines a small radius that is smaller than the radius of the second reject roller 52, and thus, as the web 8 is conveyed around the peel bar 62, the peel bar 62 causes the good-quality labels to delaminate from the web 8 and extend toward a secondary web 7 which is conveyed between and/or along a series of transfer rollers 71-75. The good-quality labels engage with the secondary web 7 and are transferred from the web 8 to the secondary web 7. The web 8 is conveyed from the first reject deadbar 51 to nip defined between the second and third reject rollers 52, 53 and further to a rewinder 300. The rewinder 300 is configured to wind the web 8 around a spool to form a roll of the web 8 containing web which can be reused on the next job/roll etc.

The secondary web 7 is conveyed from an unwinder 306 and a roll 6 of material along a first transfer roller 71 and further to a nip defined between a second transfer roller 72 and a third transfer roller 73. The good-quality labels and the web 7 pass through the nip such that the good-labels are secured to the web 7. The web 7 with the good-quality labels thereon are conveyed further to a downstream nip defined by a fourth transfer roller 74 and a fifth transfer roller 75 and from the downstream end 12 of the machine 10.

However, when a defective label (as determined by the control system 200 based on input from the inspection system 24) approaches the first reject deadbar 51, the control system 200 controls the actuator to actuate the peel bar 62 into the retracted position (depicted in FIG. 7). As such, the defective label does not transfer to the secondary web 7 and instead is conveyed with the web 8 toward the rewinder 300. Once the defective labels pass the first reject deadbar 51, the control system 200 controls the actuator to actuate the peel bar 62 back to the extended position such that subsequent good-quality labels are transferred to the secondary web 7 as described above.

In certain examples, the web 8 is stopped such that the peel bar 62 can be moved into and between the extended position and the retracted position. In other examples, the web 8 is continuously conveyed as the peel bar 62 is moved into and between the extended position and the retracted position.

In certain examples, the secondary web 7 is stopped when the defective label is being routed around the first reject roller/deadbar and/or when the peel bar 62 can be moved into and between the extended position and the retracted position. As such, there are no spaces or gaps on the web 8 and the good-quality labels are continuous along the web 8 (as depicted in FIG. 6).

The defective labels can remain on the web 8 and be included on the web 8 wound by the rewinder 300. The resulting roll of the web 8 with the defective labels can be removed from the rewinder and placed into the trash. Alternatively, the machine 10 includes an extraction system 301 which is configured to receive the defective labels from the web 8. The location of the extraction system 301 can vary, and a pair of extraction systems 301 are schematically depicted in FIG. 7. The extraction system 301 can include the waste rewind core shaft 64 such that the defective labels adhere to the outer circumference of the waste rewind core shaft 64 and are thus removed from the web 8. As such, the web 8 wound into a roll by the rewinder 300 can be reused (e.g., labels are reprinted onto the web 8) or recycled as the web 8 is devoid of defective and good-quality labels. For instance, the roll of the web 8 can be repurposed as the roll 6 of the secondary web 7.

The example machine 10 depicted in FIG. 7 does not include the first accumulator section 30, the label advance section 80, and/or the second accumulator section 40 of the machine 10 depicted in FIG. 1. As such, the machine depicted in FIG. 7 is compact with a small footprint and the length of the machine 10 in machine direction 302 is less than the length of the machine 10 depicted in FIG. 1. The machine 10 depicted in FIG. 7 can be utilized as an optional module that can be coupled to other machines (e.g., printers, slitters).

The machine 10 depicted in FIG. 7 can facilitate increased productivity, production costs, and/or quality of webs with labels thereon in comparison to the products produced by conventional machines. Some of the advantages of the machine 10 of the present disclosure include: reducing or eliminating reprints, reducing or eliminating added roll tracking (no “work in progress”), reducing or eliminating extra roll handling/inspection winder setup, integrated inspection, reducing or eliminating splices in finished rolls, enabling heavy die cut capability, enable savings in material, reducing or eliminating inspection, and/or increasing flexibility of materials that can be processed.

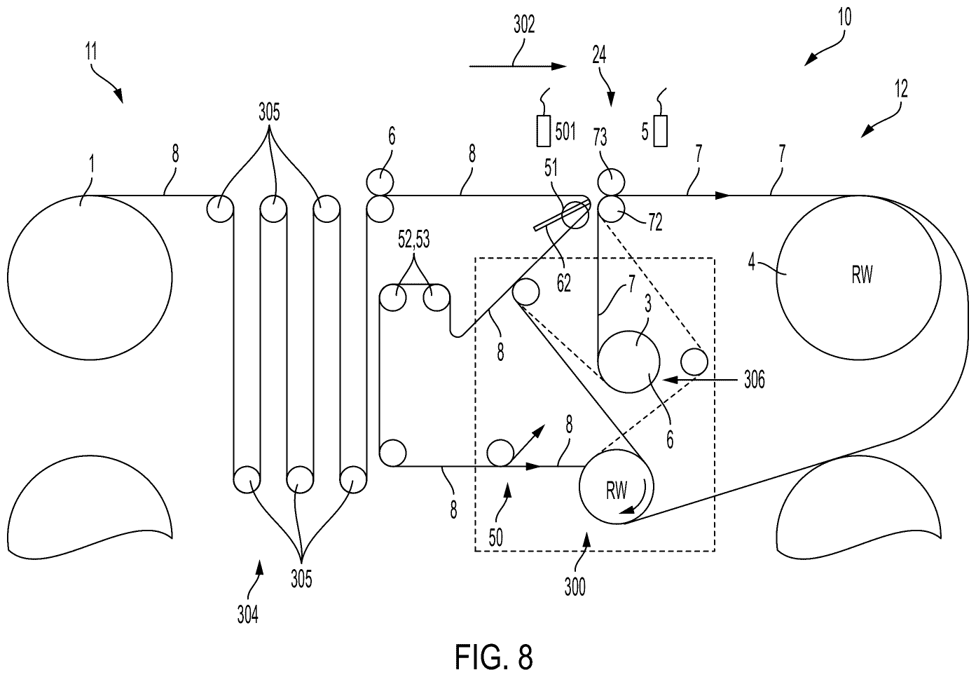

Turning now to FIG. 8, another example machine 10 is depicted. The machine 10 is similar to the machine 7 depicted in FIG. 7. The machine 10 includes a buffer section 304. The buffer section 304 includes rollers 305 that can move relative to each other to thereby adjust the amount or length of the web 8 gathered therein and account for variances in movement/speed of the web 8. As such, the buffer section 304 can prevent problems from occurring in downstream sections of the machine 10.

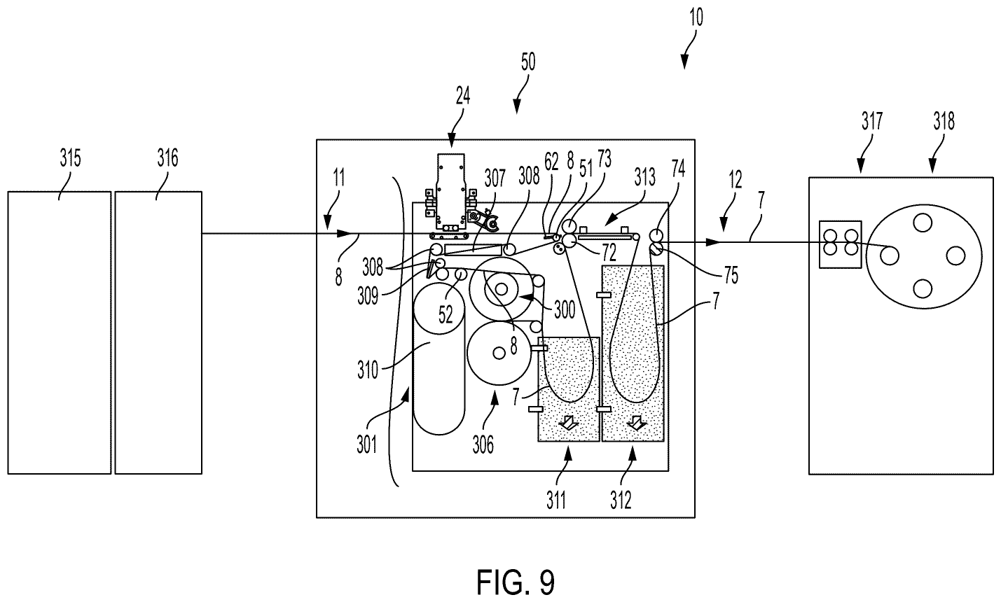

FIG. 9 depicts another example machine 10 according to the present disclosure. The extraction system 301 includes a turnbar 307 with additional rollers 308 that are downstream of the first reject deadbar 51 and upstream of the rewinder 300. The turnbar 307 is configured to prepare the web 8 for the next roll of labels to be finished (in some examples the web 8 is coated with a releasing compound so the adhesive on the label will release cleanly from the web 8). The turnbar 307 prepares the roll for the next job, such that the release coated surface is in the correct orientation to receive new labels. A second peel bar 309 is included for causing the defective label to fall into a receptacle 310.

The machine 10 includes a first web buffer or fan box 311 that is downstream from the unwinder 306 and upstream from the second transfer roller 72. The fan box 311 is configured to contain an amount or length of the secondary web 7 gathered therein and account for instances when variances in movement/speed of the secondary web 7. The fan box 311 are also commonly referred to ‘slack web’ machines. The fan box 311 allow for a very fast deceleration and acceleration rates of webs such that the machine can be easily started and stopped. The fan box 311 can be utilized to rapidly stop, reverse, and/or accelerate the web 8 when a defect is removed. This rapid start stop can allow higher total machine throughput. The fan boxes 311 can also allow the rewinder 300 and the unwinder 306 more buffer to slow down as well as start. In some cases, the amount of material in the fan box 311 will only change a few inches. This deviation in buffer can then be smoothly replaced by briefly increasing the unwind speed.

A splice table 313 is located downstream of the second transfer roller 72 and provides a location at which the operator can splice two ends of the secondary web 7 together, as necessary. Optionally, a second web buffer or fan box 312 that is downstream from the splice table 313. The second fan box 312 is similar to the first fan box 311.

The location of the rewinder 300 and the unwinder 306 can be reversed, and in certain examples, once the rewinder 300 if full, the machine 10 can be configured to cause the rewinder 300 to act in the place of the unwinder 306 and dispense web on which the good-quality labels are transferred.

The example machine 10 depicted in FIG. 8 is located downstream of an unwinder machine 315 and a printing press or printer 316. The machine 10 is also located upstream of an EPOS 317 and/or turret 318. The EPOS and/or the turret 318 is an automatic web slitter positioning system which are common in the industry. These components are for job setups containing multiple lanes of products or where precise slitting is needed and setup time is limited between jobs.

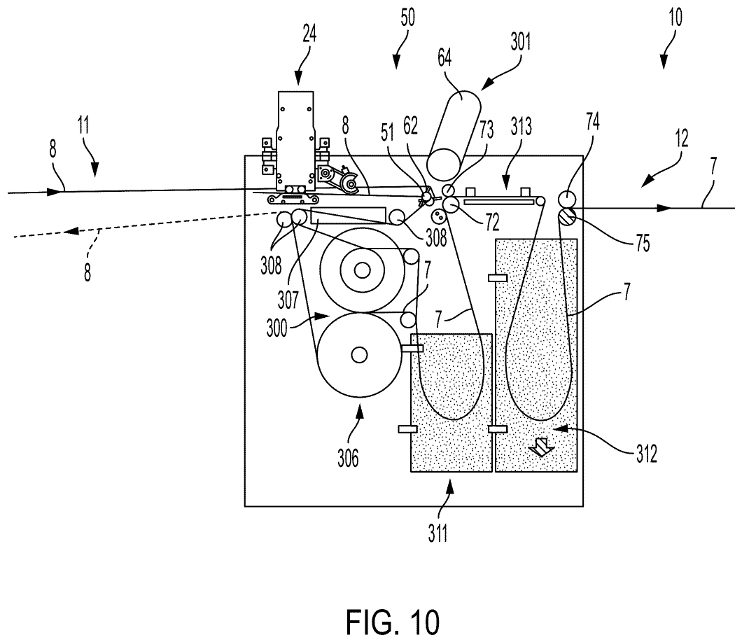

FIG. 10 depicts another example machine 10 according to the present disclosure. The extraction system 301 includes a waste rewind core shaft 64, and the peel bar 62 and the first reject roller 52 are movable together into a first position in which the peel bar 62 causes the good-quality labels to transfer to the secondary web 7 and a second position in which the peer bar causes the good-quality labels to the waste rewind core shaft 64 (note that both the first position and the second position of the peel bar 62 and the reject roller 52 are depicted in FIG. 10). In certain examples, the control system 200 controls an actuator (not depicted) to move both the peel bar 62 and the first reject roller 52 between the first position and the second position. In the example depicted in FIG. 10, the machine 10 can optionally convey the web 8 back out the upstream end 11 after the defective labels are removed from the web 8. The web could be conveyed back to printer or other upstream machine. In certain examples, the machine 10 depicted in FIG. 10 is placed at the end of a line of machines that produce labels.

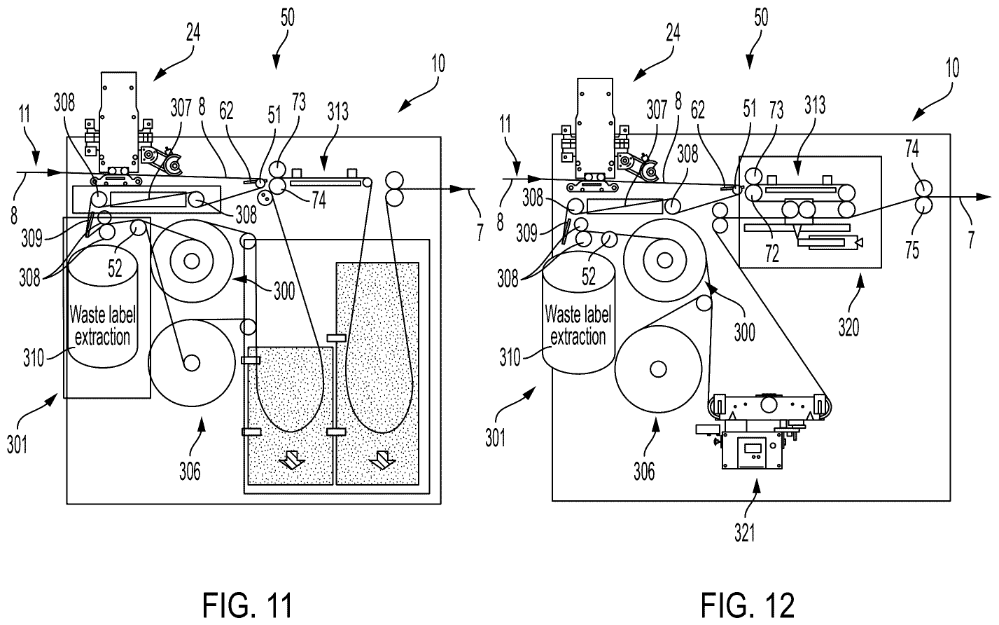

FIG. 11-13 depict additional examples of a machine according to the present disclosure.

FIG. 11 depicts an example machine 10 with the small receptacle 310 in which defective labels are deposited by the extraction system 301. The receptacle 310 can fit within a housing (not depicted) of the machine 10.

FIG. 12 depicts an example machine 10 with a semi rotary shuttle 320 which is known in the industry and configured to rapidly position the web 8 without slowing down the input and outgoing web speeds. In this example, the semi rotary shuttle 320 is used as a buffer to decouple the line speed and give the winders a longer time to decelerate or more precisely position the labels on the receiving web at and during the transfer process. The machine 10 also includes a web guide system 321 that is configured to guide the secondary web 7 so that the good-quality labels would remain in the correct position during the transfer process.

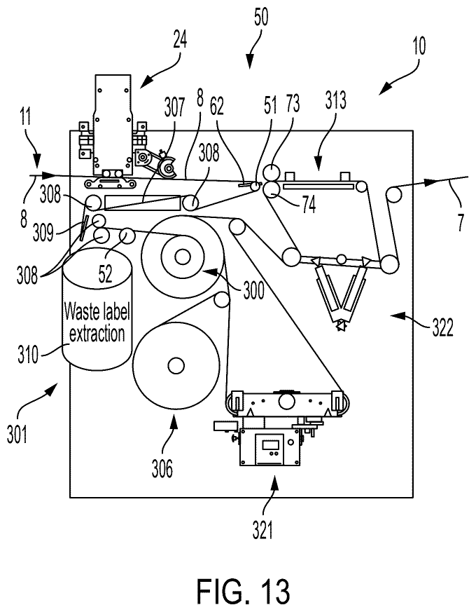

FIG. 13 depicts an example machine 10 with a dancer system 322 that is configured to buffer the secondary web 7 and maintain a constant tension during the rapid stopping and starting process that may be needed in some machines to meet production speeds. As such in certain examples, the dancer system 322 acts as another buffer.

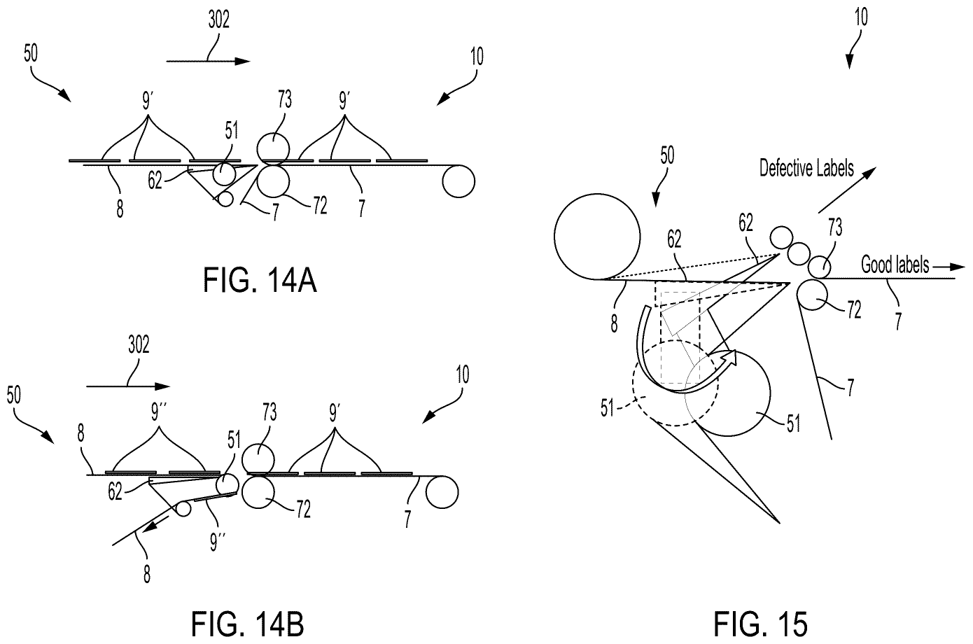

FIGS. 14A and 14B depict another example defect reject section 50 according to the present disclosure. In FIG. 14A, the web 8 is conveyed along and around the first reject roller/deadbar 51 and over the peel bar 62 which is in the extended position. As such, the good-quality label 9′ transfers from the web 8 to the secondary web 7. The web 8 and the secondary web 9 are moving at the same speed such that the distance between the good-quality labels 9′ is maintained as the good-quality labels 9′ are transferred between the webs 8, 7. In FIG. 14B, the web 8 is conveyed with defective labels 9″ and the peel bar 62 is moved to the retracted position such that the defective labels 9″ remain on the web 8 and do not transfer to the secondary web 7. In these situations, the control system 200 stops conveyance of the secondary web 7 until the peel bar 62 is moved to the extended position and/or the good-quality label engages the secondary web 7. In certain examples, the control system 200 is configured convey the secondary web 7 in the reverse direction (e.g., back toward the unwinder 306) to account for startup time and/or match the speed of the web 8 when the secondary web 7 is again conveyed in the forward direction.

FIG. 15 depicts another example defect reject section 50 according to the present disclosure. In this example, one or more rollers/deadbars 51 and the peel bar 62 are moveable together into different positions to thereby transfer the labels. In a first position (see dashed lines), the good-quality labels are transferred to the secondary web 7. When defective labels are detected, the rollers/deadbars 51 and the peel bar 62 pivot to a second position (see solid lines) in which the defective labels are transferred to reject rollers 325, a defect receptacle, and/or a defect web.

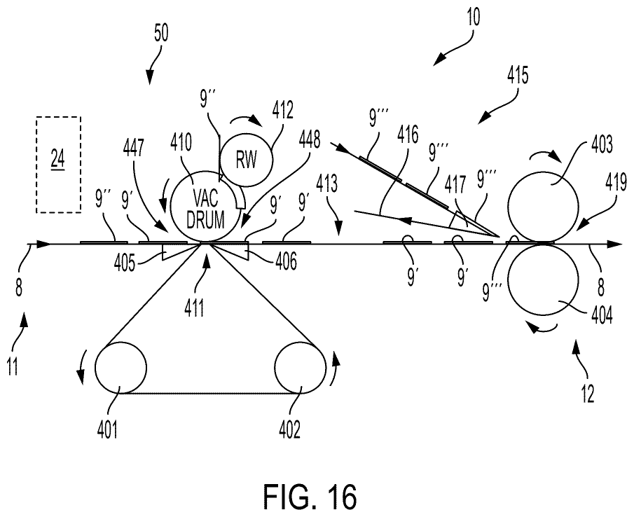

FIG. 16 depicts another example machine 10 according to the present disclosure. The machine 10 receives the web 8 with the good-quality labels 9′ and the defective labels 9″ thereon via the upstream end 11. The web 8 and labels are scanned by the inspection system 24 and conveyed to the example defect reject section 50.

The defect reject section 50 is configured to remove defective labels 9″ from the web 8 that are identified as defective by the inspection system 24. The web 8 is conveyed to and/or along a series of rollers, and in the example depicted in FIG. 16 the defect reject section 50 includes a first roller 401, a second roller 402, a third roller 403, and a fourth roller 404. Note that one or more of the rollers 401-404 may be drive rollers.

The web 8 is also conveyed along one or more peel bars 405, 406. Note that in other examples, the second peel bar 406 could be replaced with a roller. As the web 8 is conveyed along the first peel bar 405, the first peel bar 405 causes all labels 9′, 9″ on the web 8 to delaminate from the web 8 and continued movement of the web 8 causes the labels 9′, 9″ to extend across a gap 411 that is located between the a first section 447 of the web 8 moving around the peel bar 405 and a second section 448 of the web 8 moving around the peel bar 406. Note that after the labels 9′, 9″ are delaminated from the web 8, the web 8 is conveyed around the first roller 401, the second roller 402, and the second peel bar 406. The good-quality labels 9′ extend across the gap 411 and reengage with and relaminate to the web 8 downstream of the gap 411.

The labels 9′, 9″ pass along a label removal system, such as a vacuum drum 410 or a rotating shaft with gripper that is configured to engage and remove any defective labels 9″ (as identified by the inspection system 24 and/or the control system 200) as the defective labels 9″ extend across the gap 411 such that the defective labels 9″ do not transfer back onto the web 8 downstream of the gap 411. Instead, the vacuum drum 410, which includes a vacuum system that is operated by the control system 200, generates a vacuum that causes the defective labels 9″ to stick to the vacuum drum 410. The defective label 9″ on the vacuum drum 410 rotates with the vacuum drum 410 and is transferred to a reject roller 412. Note that the vacuum drum 410 could be configured to remove a single label on the web 8 or more than one label in a row of labels that extends in the cross-machine direction. The vacuum drum 410 could be segmented such that one or more specific labels are removed.

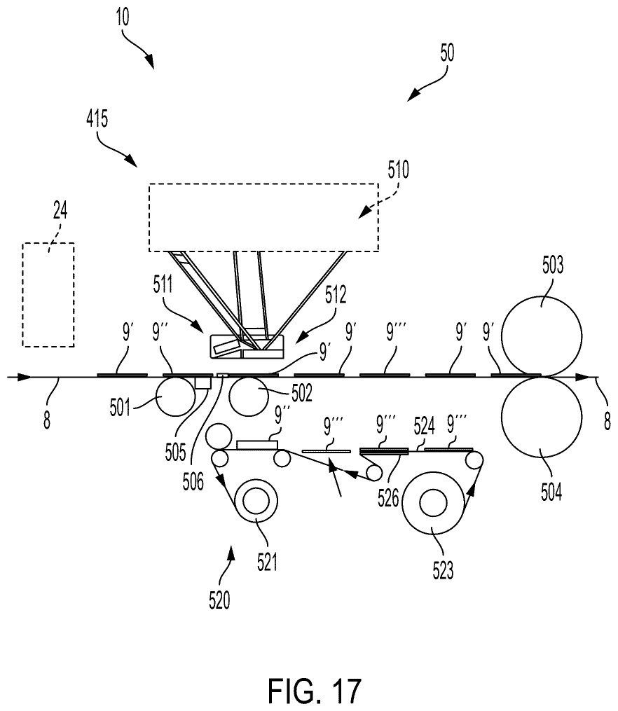

With the defective label 9″ removed from the web 8, there is a space 413 on the web 8 that does not contain a label. The machine 10 includes one or more label replacement system 415 that is configured to dispense a replacement good-quality label 9′ onto the web 8 in the space 413. In the example depicted in FIG. 16, the label replacement system 415 includes a roll of good-quality labels 9′ that are on a secondary web 416. Note that in another examples, the label replacement system 415 is a robot (see for example the robot 510 of FIG. 17). The secondary web 416 extends around a third peel bar 417. The control system 200 is configured to control the movement of the secondary web 416. In operation, as the space 413 approaches and/or is near the third peel bar 417 the control system 200 moves the secondary web 416 (e.g., the control system 200 controls a drive roller to cause the secondary web 416 to move) such that the replacement good-quality label 9′″ is moved around the third peel bar 417 and delaminates and extends from the secondary web 416. The replacement good-quality label 9′″ engages and laminates to the web 8 in the space 413. Note that the web 8 can be continuously moving or stationary when the replacement good-quality label 9′″ engages the web 8. The replacement good-quality label 9′″ and the good-quality labels 9′ pass through a nip 419 defined between the third roller 403 and the fourth roller 404. The labels 9′, 9′″ are compressed onto the web 8 in the nip. As such the web 8 being conveyed downstream is filled with labels 9′, 9′″ without any spaces 413 on the web 8.

Referring to FIG. 17, another example machine 10 according to the present disclosure is depicted. The machine 10 receives the web 8 with the good-quality labels 9′ and the defective labels 9″ thereon via the upstream end 11. The web 8 and labels 9′, 9″ are scanned by the inspection system 24 and conveyed with the web 8 to the example defect reject section 50. The defect reject section 50 is configured to remove defective labels 9″ from the web 8 that are identified as defective by the inspection system 24.

The web 8 is conveyed to and/or along a series of rollers, and in the example machine 10 depicted in FIG. 17 includes a first roller 501, a second roller 502, a third roller 503, and a fourth roller 504. Note that one or more of the rollers 501-504 may be drive rollers.

The web 8 is also conveyed along one or more peel bars 505 located along the web 8 and between the first roller 501 and the second roller 502. An additional peel bar 506 is located adjacent to the peel bar 505 and configured to engage and bend the web 8 when it is moved, for example, the peel bar 506 is moved by a pneumatic cylinder. Note that the peel bar(s) 505, 506 can operationally cause the leading edge of the labels 9′, 9″ to extend from the web 8 and/or delaminate from the web 8.

In this example, the label replacement system 415 includes a robot 510 located near the web 8 and moveable into different operational positions (described further herein). The robot 510 is generally movable in three dimensions relative to the web 8. In certain examples, the robot 510 is a delta robot. In certain examples, the robot 510 includes an articulated arm, one or more support or guide arms, one or more actuators, and/or is a gantry-type motion system. The robot 510 can include a removal member, such as a wedge 511, that is for lifting and/or removing (e.g., wedging between) the leading edge of defective labels 9″ from the web 8 such that the defective label 9″ can be lifted off the web 8 (described further herein). The robot 510 also includes a gripping member 512 that is configured to hold a replacement good-quality label 9′″ thereon. In certain examples, the gripping member 512 includes a vacuum pad that includes the wedge 511 such that the gripping member can grip the leading edge of the defective label 9″. Note that is in certain examples the robot 510 is and functions as a label removal system and/or a label replacement system.

In certain examples, the gripping member 512 includes a vacuum pad to hold the replacement good-quality label 9′″ from their face-side so the labels may be placed on the web adhesive-side down. The vacuum pad may be curved such that labels are “rolled” onto the web from the leading edge, which prevents trapped air or wrinkles which may result if the label is placed down all at once. The rolling effect may be produced by an internal hinge or pivot point of the robot 510 which allows the vacuum pad to pivot as the robot 510 is moved, or with a servo-controlled pivot axis on the robot 510 which allows the control system 200 to change the angle of the robot 510 and/or the wedge 511. The robot 510 could have separate gripping members 512 for replacement good-quality labels and defective labels, or a single pad that serves to remove defects, pick up replacement good-quality labels, and place good-quality labels on the web 8. The wedge 511 can be used to trap the leading edge of a defective label on the gripping member 512, such that the rolling motion of the gripping member picks up the defective label and removes it from the web. In other examples, the gripping member 512 includes a gripping pad including a vacuum pump for creating a vacuum, a gripping pad including a fan for creating the vacuum, a gripping pad including a venturi for creating a vacuum, and/or static pinning device.

An extraction system 520 is located near the robot 510 which is configured to receive the defective labels 9″ from the robot 510. The extraction system 520 includes one or more rollers 521. The extraction system 520 may be associated with and/or integral with a supply roll 523 having a supply web 524 with replacement good-quality label 9′″ thereon. The supply web 524 is routed along one more rollers 525 and a peel bar 526. The supply web 524 extends to the roller 521 of the extraction system 520 and is wound around the roller 521 (as described further herein).

Generally, the robot 510 is configured to remove a single defective label 9″, place a good-quality label 9′ in the place vacated by the removed, place the defective label 9″ onto the supply web 524 at the extraction system 520, and/or then pick up a new replacement good-quality label 9′″ from the supply web 524 to be used for the next defective label 9″ that is identified and removed from the web 8. The robot 510 is configured to remove the defective label 9″ from any lane on the web 8 (e.g., there are five lanes of labels in the cross-machine direction on the web). The present inventors recognized that it would be advantageous to use the robot 510 to thereby efficiently and effectively reduce waste by removing only defective labels, even when the good- quality labels are produced and organized in multiple lanes on the web 8.

In one example operational sequence, the inspection system 24 images the labels on the web 8. Note that the inspection system 24 can be configured to image one or more lanes of labels on the web 8. The control system 200 based on outputs (e.g., signals, data) from the inspection system 24 determines the location of a defective label 9″ on the web 8. The control system 200 controls the web to slow or stop the leading edge of the defective label 9″ at a “removal position” or “removal station” relative to the peel bar 505. The control system 200 controls the actuator 506 to bend the web 8 such that the leading edge of the defective label 9″ is delaminated from the web 8 and/or presented to the wedge 511. The control system 200 then moves the robot 510 such that the wedge 511 slides under the defective label 9″ and the replacement good-quality label 9′″ on the gripping member 512 is placed onto the web 8 in the same location as the removed defective label 9″ on the web 8.

The robot 510 then moves the defective label 9″ onto the supply web 524 at the extraction system 520 and moves to grab another replacement good-quality label 9′″ the supply web 524. The control system 200 then moves the supply web 524 forward such that another replacement good-quality label 9′″ is ready for the robot 510 and another space is available on the supply web 524 for the next defective label 9″.

In certain examples, the inspection system 24, the control system 200, and/or some other auxiliary imaging system are configured to image and/or determine parameters of the replacement good-quality labels on the web relative to the other labels on the web. The system can measure the actual position of the replacement good-quality labels with respect to the other labels on the web, and the robot 510 can be configured to remove and replace the replacement good-quality label if the replacement good-quality label is not in the proper position on the web and/or is not within a predetermined tolerance from the location of the defective label on the web.

In certain examples, the supply roll 523 containing replacement good-quality label 9′″ is created by the machine 10 by winding the web 8 with good-quality labels 9′ as described above. The peel bar 526 is located downstream of the robot 510 and the control system 200 is placed into a supply roll creation operational mode. In this mode, the machine 10 removes defective labels as noted above, but would not replace the defective labels 9″, and then all the good-quality labels would be transferred to a new supply web 524. The machine would continue to collect good-quality labels until a setpoint for number-to-collect was reached. That setpoint could be changed by the operator, or, if the machine 10 is using a Workflow process and a roll- map, thus the machine 10 knows the number of defects contained in the supply roll without having to inspect inline, the machine will collect enough labels to replace all the defects. Once enough good-quality labels are collected, the machine 10 enters normal operational mode and proceeds to remove defects and replace them with the good-quality labels as noted above.

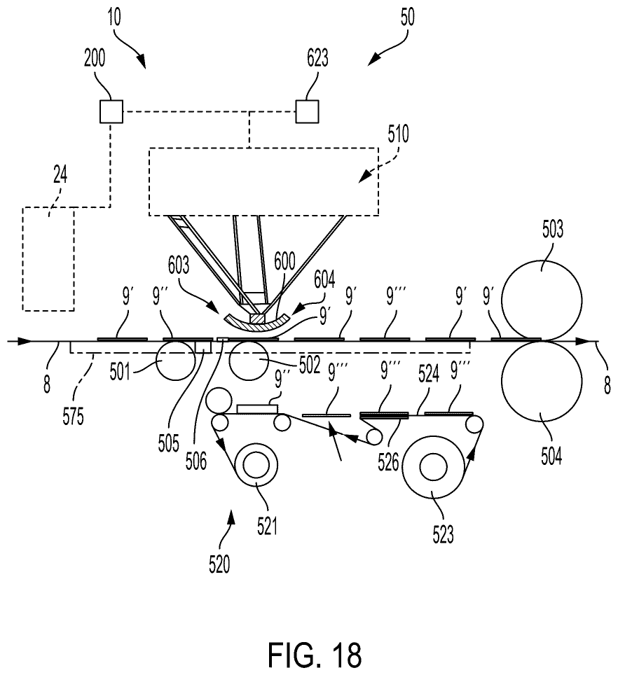

Referring to FIG. 18, another example machine 10 with an example defect reject section 50 according to the present disclosure is depicted. The machine 10 includes features and/or components similar to the machine 10 depicted in FIG. 17.

The web 8 can be conveyed along one or more peel bars 505 located along the web 8 and between the first roller 501 and the second roller 502. In certain examples, an additional peel bar 506 is located adjacent to the peel bar 505 and configured to engage and bend the web 8 when it is moved, for example, the peel bar 506 is moved by a pneumatic cylinder. Note that the peel bar(s) 505, 506 can operationally cause the leading edge of the labels 9′, 9″ to extend from the web 8 and/or delaminate from the web 8.

The robot 510 is this example includes another example gripping member 600 according to the present disclosure that is moveable into different operational positions (described further herein). As will be described in greater detail herein below, the robot 510 moves the gripping member 600 relative to the web 8 to thereby remove defective labels from the web 8 and/or replace good labels onto the web 8.

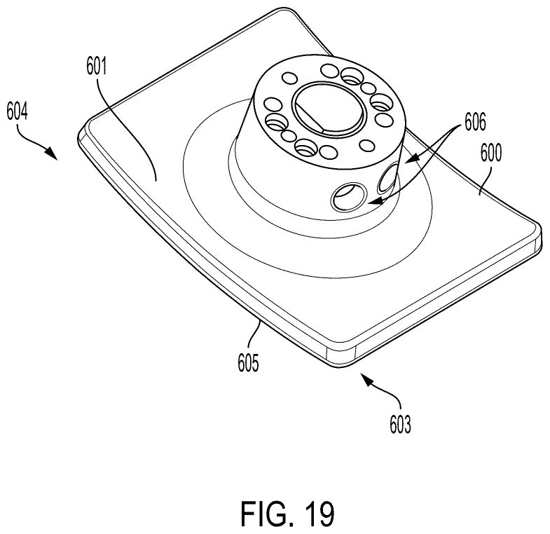

FIGS. 19-21 depict the example gripping member 600 in greater detail. The gripping member 600. The gripping member 600 has a body 601 with a first end 603 and a second end 604. An engagement surface 605 extends between the end 603, 604. The engagement surface 605 extends along a radius such that the engagement surface 605 is a convex surface. The engagement surface 605 being curved advantageously prevents trapped air between the engagement surface 605 and the label and/or prevents wrinkles on the labels which may result if engagement surface 605 engages the label (defective or good-quality label) at once.

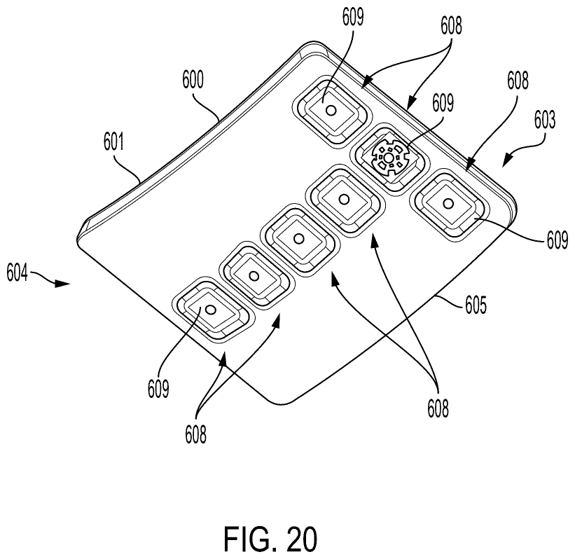

The body 601 includes one or more ports 606 that are configured to receive vacuum and/or air from a vacuum or air system (not depicted; e.g., vacuum generating system, pneumatic venturi vacuum generator) of the machine 10. The ports 606 are coupled to a plurality of channels 607 that extends internally through the body 601 through which a vacuum that is generated by an air system 623 that is controlled by the control system 200 creates a suction forces is routed to one or more engagement zones 608 of the engagement surface 605 such that the labels are coupled (e.g., ‘sucked’) to the engagement surface 605. The engagement zones 608 the number, spacing, size, and/or shape of the engagement zones 608 can vary, and in the example depicted in FIG. 20, seven engagement zones 608 are included and the engagement zones 608 are generally rectangular and arranged in a “T” shape. In other examples, an array of engagement zones 608 and/or suction devices 609 (described below) are along a majority of the engagement surface 605 and the control system 200 is configured to direct suction to one or more of the engagement zones 608 and/or the suction devices 609 based on the size of the labels (e.g., only a few engagement zones 608 and/or the suction devices 609 are using suction so that adjacent labels are not inadvertently lifted off the web 8).

A suction device 609 is coupled to the engagement surface 605 at each engagement zone 608. The suction device 609 includes elastically deformable walls 612 that deform as the suction device 609 engages a label or the web 8. The suction device 609 includes one or more openings 610 therein and a perimeter flange 611 that engages with the engagement surface 605. Note that in other examples, the suction devices 609 are excluded. In another example, the suction device 609 is a flexible sheet made of, e.g., closed-cell polyurethane foam, with perforation therein that extends across the engagement zone 608. In certain examples, the suction device 609 includes protrusions (note depicted). In certain examples, the engagement surface 605 and/or the engagement zone 608 are covered with a flexible sheet of elastic and/or compressible foam.

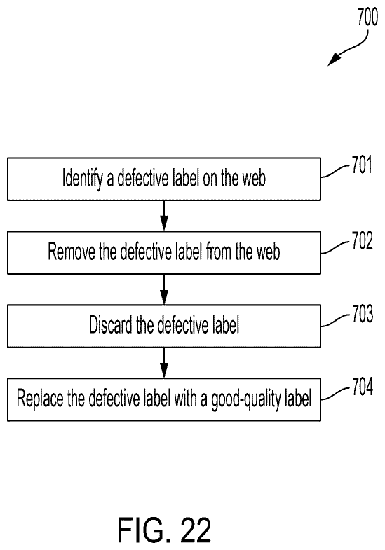

An example method 700 for operating the robot 510 with the gripping member 600 is described below with reference to FIGS. 22-25.

The method 700 begins at step 701 with identifying a defective label 9″ with the inspection system 24 (see for example FIG. 7) and the control system 200 determining a position in which to stop conveyance of the web 8 such that the robot 510 can engage the web 8 and the defective label 9″.

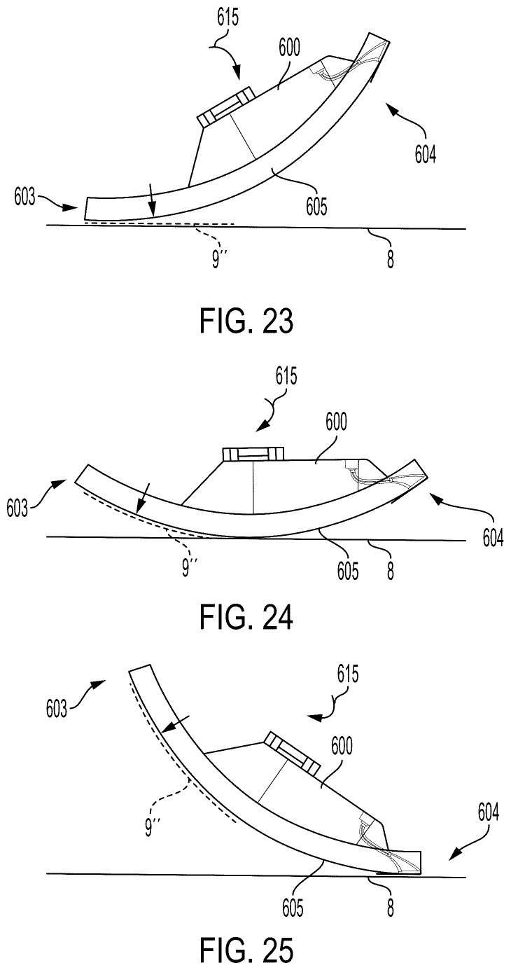

At step 702 the robot 510 removes the defective label 9″ from the web 8. To remove the defective label 9″, the robot 510 moves the gripping member 600 into engagement with an edge of the defective label 9″ (depicted in dashed lines in FIGS. 23-25). The robot 510 pivots the gripping member 600 such that the first end 603 engages with the edge of the defective label 9″ (see FIG. 23). The control system 200 causes suction forces to be applied via one or more suction devices 609 to the defective label 9″. The walls 612 of the suction devices 609 may deform. The robot 510 then pivots (see example pivot direction 615) the gripping member 600 such that the gripping member 600 ‘rolls’ along the defective label 9″ and the web 8 (see FIGS. 24-25. As such, the defective label 9″ is progressively peeled off the web 8 and the suction forces hole the defective label 9″ on the engagement surface 605. Note that the control system 200 can be configured to cause suction to different suction devices 609 (e.g., the control system 200 individually controls suction along various channels 607) as the gripping member 600 is pivoted by operating valves (not depicted).

After the defective label 9″ is removed from the web 8 (see FIG. 25), the robot 510 moves and/or pivots the gripping member 600 and the defective label 9″ is discarded at step 703 (e.g., suction is stopped and the defective label 9″ falls into a waste basket, the robot 510 moves the gripping member 600 into engagement with a discard roll such that the defective label 9″ sticks to the discard roll).

At step 704 the robot 510 picks up and/or places a replacement good-quality label 9′″ onto the web 8 in a location where the defective label 9″ was removed. Note that this step of placing the replacement good-quality label 9′″ can include one or sub steps. In one example, after the defective label 9″ is discarded, the robot 510 moves the gripping member 600 to another web with the good-quality label 9′″ thereon. The robot 510 then moves the gripping member 600 in a similar manner as is described above with respect to removing the defective label 9″ to pick up the good-quality label 9′″. The robot 510 then moves the gripping member 600 to the web 8 and moves the moves the gripping member 600 in a similar manner as is described above with respect to removing the defective label 9″ while stopping suction of the good-quality label 9′″ on the engagement surface 605 such that the good-quality label 9′″ adheres to the web 8.

Note that the above described example method 700 can include any other features described in the present disclosure with respect to any example machine 10 and/or example defect reject section 50 described herein. For example, the method 700 could include the additional steps of the control system 200 controls an actuator to bend the web 8 such that the leading edge of the defective label 9″ is delaminated from the web 8 thereby facilitating easy and effective removal of the defective label 9″ by the gripping member 600. Further note that the certain steps of the example method 700 can be interchanges or excluded. For example, the gripping member 600 can have the good-quality label 9′″ thereon when the gripping member 600 removes the defective label 9″. In this example, the gripping member 600 can replace the good-quality label 9′″ onto the web 8 before discarding the defective label 9″.

In another example, the machine 10 includes a semi rotary shuttle 575 (schematically depicted in dash-dot lines in FIG. 18) configured to rapidly position the web 8 without slowing down the incoming and outgoing web speeds. The semi rotary shuttle 575 is used as a buffer to decouple the line speed and give the winders a longer time to decelerate In certain examples, the shuttle 575 is configured to decouple the speed of the web 8 in an internal process zone from the speed of the web 8 upstream and downstream of the shuttle 575 by superimposing the velocity of a moving idler roller carriage onto the speed of the web 8, thus locally controlling the speed of the web 8 in the internal process zone independently from the other areas of the machine 10. In certain examples of an example machine 10 with a shuttle 575 and a robot 510, the machine 10 may run at a continuous web speed without stopping to remove and replace defects while the shuttle 575 stops the web 8 within its internal process zone and the robot 510 removes defects and places replacement labels. In another example, the shuttle 575 enables replacement labels to be re-inspected by reversing the web 8 such that the replaced good-quality label passes through the inspection system 24. In another example, the machine 10 with the shuttle 575 and the robot 510, the inspection system 24 located on the downstream side of the robot 510 such that when a defective label is detected by the inspection system 24, the control system 200 causes the shuttle 575 to reverse the web 8 past the robot 510 and stop so the robot 510 may engage with the defective label. After repairing the defective label, the replacement good-quality label is re-inspected by the inspection system 24 because the replacement good-quality label passes through the inspection system 24 again.

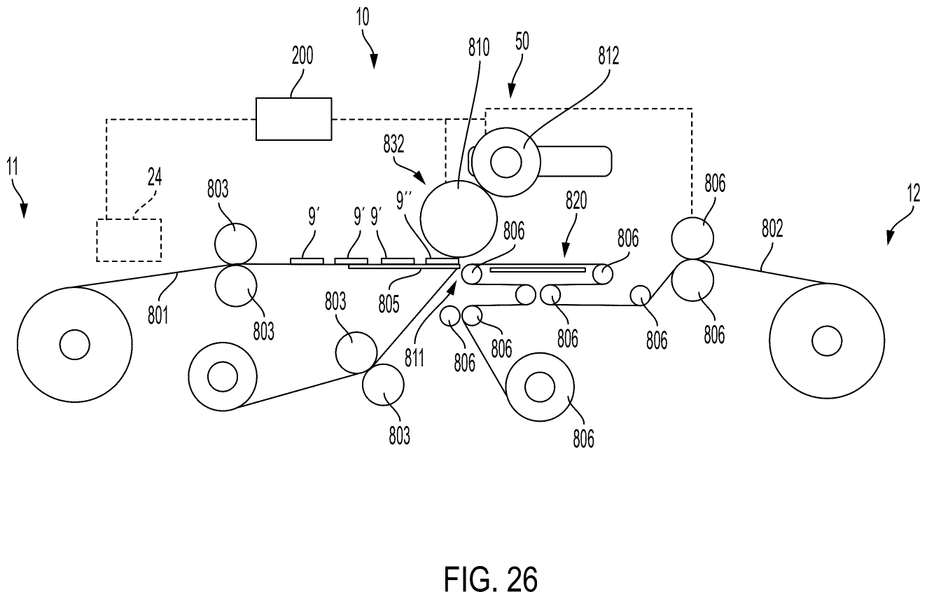

Referring now to FIG. 26, another example machine 10 is depicted. The machine 10 receives a first web 801 with the good-quality labels 9′ and the defective labels 9″ thereon via the upstream end 11. The first web 801 and labels 9′, 9″ are scanned by the inspection system 24 and conveyed with the first web 801 to the example defect reject section 50. The defect reject section 50 is configured to remove defective labels 9″ from the first web 801 that are identified as defective by the inspection system 24.

The first web 801 is conveyed to and/or along a series of rollers 803 and/or along one or more peel bars 805. The peel bar 805 is configured to cause the leading edge of the labels 9′, 9″ to extend from the first web 801 and/or delaminate from the first web 801. The good-quality labels 9′ can then engage with a second web 802.

The second web 802 is conveyed to and/or along a series of rollers 806, the second web 802 is configured to receive good-quality labels 9′ from the first web 801 that are delaminated from the first web 801 by the peer bar 805. The speed of the second web 802 is controlled by the control system 200.

In operation, the inspection system 24 images the labels on the first web 801. The control system 200 based on outputs (e.g., signals, data) from the inspection system 24 determines the location of a defective label 9″ on the first web 801, and the control system 200 operates a label removal system 832, such as a vacuum drum 810 or a robot (see example robot 510 in FIG. 18), that is configured remove the defective label 9″ from the first web 801. In examples of the label removal system being a vacuum drum 810, the vacuum drum 810 engages and removes any defective labels 9″ as the defective labels 9″ extend across a gap 811 between the first web 801 and the second web 802 such that the defective labels 9″ do not transfer onto the second web 802. Instead, the vacuum drum 810, which includes a vacuum system that is operated by the control system 200, generates a vacuum that causes the defective labels 9″ to stick to the vacuum drum 810. The defective label 9″ on the vacuum drum 810 rotates with the vacuum drum 810 and is transferred to a reject roller 812. Note that the vacuum drum 810 could be configured to remove a single label on the first web 801 or more than one label in a row of labels that extends in the cross-machine direction. The vacuum drum 810 could be segmented such that one or more specific labels are removed. Note that in other examples, the vacuum drum 810 is replaced by a robot (for example the robot 510 depicted in FIG. 18) that is configured to remove the defective labels 9″ from the first web 801.

Good-quality labels 9′ are received onto the second web 802 and wound with the second web 802 at the second end 12 of the machine 10. The speed of the second web 802 can match the speed of the first web 801, and in the event that the defective labels 9′″ are removed (as described above), the speed of the second web 802 can be slowed or stopped so that the next upstream set of good-quality labels 9′ are received into the space vacated by the removed the defective labels 9″. As such, the second web 802 can have no gaps in the good-quality labels 9′.

In another example, the machine 10 includes a semi rotary shuttle 820 configured to move (e.g., rapidly position) the second web 802 without slowing down an upstream web speed (e.g., incoming web speed) and a downstream web speed (e.g., outgoing web speed) of the second web 802 thereby allow the first web 801 to be run continuously. The semi rotary shuttle 820 is used as a buffer to decouple the line speed and give the winders a longer time to decelerate or more precisely position the second web 802 such that the good quality labels 9′ are received onto the second web 802 from the first web 801. In certain examples, running the first web 801 continuously advantageously permits the machine 10 to be used in-line with other upstream equipment, such as a printing presses, without requiring the upstream equipment to stop when defective labels are removed.

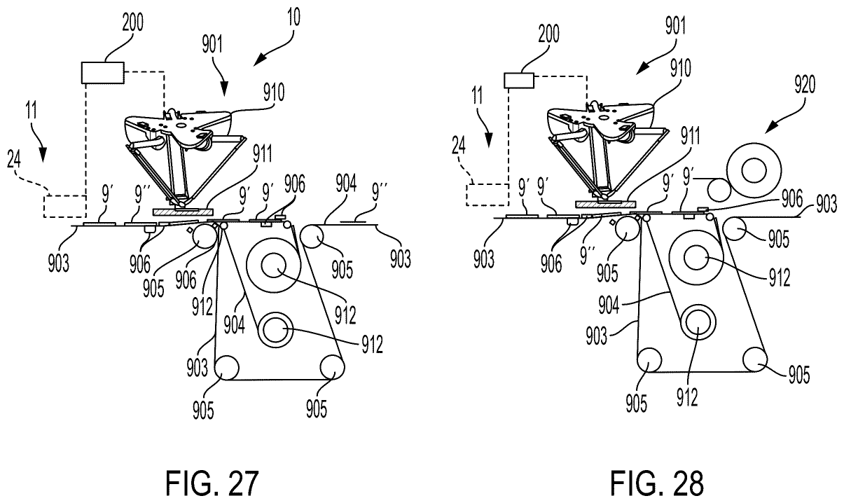

Referring to FIG. 27, another example machine 10 is depicted. The machine 10 includes a quality roll section 901 that is configured to accumulate only good-quality labels 9′ and the roll of only good-quality labels 9′ can be utilized in a different machine 10 (some of which are described herein).

The quality roll section 901 receives the first web 903 with the good-quality labels 9′ and the defective labels 9″ thereon via the upstream end 11. The first web 903 and labels 9′, 9″ are scanned by an inspection system 24.

The first web 903 is conveyed to and/or along a series of rollers 905 and/or along one or more peel bars 906. The peel bar 906 is configured to cause the leading edge of the labels 9′, 9″ to extend from the first web 801 and/or delaminate from the first web 903. The good-quality labels 9′ can then engage with a second web 904 (e.g., a supply web). A robot 910 with a gripping member 911 (similar to other example robots and gripping members described in other example machines 10 described in the present disclosure) can be configured to pick up a good-quality labels 9′ for use downstream in the machine 10.

In operation, the inspection system 24 images the labels on the first web 903. The control system 200 based on outputs (e.g., signals, data) from the inspection system 24 determines the location of a defective label 9″ on the first web 801. The control system 200 controls an actuator (not depicted) such that good-quality labels 9′ delaminate from the first web 903 and laminate to the second web 904. However, defective labels 9″ remain on the first web 903 and are conveyed downstream for manual inspection and/or to be discarded. A such, the second web 904 wound about one of the roller 912 has only good-quality labels 9′ thereon. This roll of the second web 904 with the good-quality labels 9′ can be utilized as a supply of good-quality labels 9′. In certain examples, when a good-quality label 9′ is removed from the web of the roll of good- quality labels 9′, a robot can place a defective label 9″ in the location on the second web 904 when the good-quality label 9′ is removed.

In another example, the machine 10 accumulates the good-quality labels 9′ on the roll of the second web 904 as described above with respect to FIG. 27, and once the roll is completed, additional good-quality labels 9′ are conveyed downstream to other sections of the machine 10 (for example the defect rejection section 50 depicted in FIG. 18). In certain examples, after the machine 10 accumulates the good-quality labels 9′ on the roll of the second web 904 as described above with respect to FIG. 27, the machine 10 can continue to operate such that the labels are inspected as described above with in a defect reject section such as respect to other example machines 10

In certain examples, the quality roll section 901 can be located upstream or downstream from a defect reject section 50 such as an example defect reject section 50 described herein in other example machines 10 of the present disclosure. In certain instances, the first web 903 an upstream or downstream section of the web 8 depicted other examples of the present disclosure. The labels are inspected and the robot 910 can be configured to remove the defective label 9 from the web 903 and replace a good-quality label from the second web 904 that can be unwound from the roller 912. The robot 910 can place the defective label 9″ onto the second web 904. Note that the machine 10 could have one robot or more than one robot (e.g., one robot for picking good-quality labels 9′ and placing the good-quality labels 9′ onto the second web 903 and a second robot that picks the defective labels 9″ and place the defective labels onto the second web 903).

FIG. 28 depicts another example machine 10 similar to the machine depicted in FIG. 27. In this example, the robot 910 is configured to remove defective labels 9″ from the first web 903 and place the defective labels 9″ onto a waste drum or waste rewind roll 920. Additionally or alternately, in certain examples, the labels are inspected downstream or upstream at an example defect reject section 50 (see for example FIG. 18) and the robot 910 (or another robot) can be configured to remove the defective label 9 from the web 903 and replace a good-quality label from the second web 904 onto the first web 903. The robot 910 can place the defective label 9″ onto the waste drum or waste rewind roll 920.

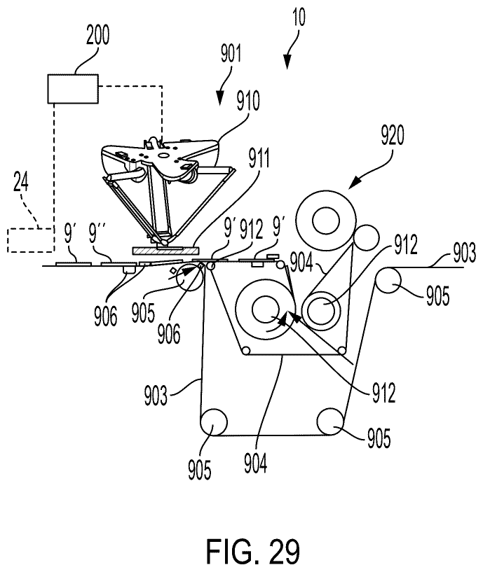

FIG. 29 depicts another example machine 10 similar to the machine 10 depicted in FIG. 27. In this example, the labels are inspected downstream or upstream at an example defect reject section 50 (see for example FIG. 18) and the robot 910 (or another robot) can be configured to remove the defective label 9 from the web 903 and replace a good-quality label from the second web 904 onto the first web 903. The robot 910 then places the defective label 9″ onto the second web 904. The second web 904 can be routed to a waste drum or waste rewind roll 920 such that the defective label 9″ is removed (e.g., peeled off with the help of a peel bar) from the second web 904 onto the waste drum or waste rewind roll 920. As such, the second web 904 can be used multiple times for receiving good-quality labels 9′ and receiving defective labels 9″ each of which are selectively removed during operation of the machine 10.

In certain examples, a machine for removing a defective label from a first web with a good-quality label thereon includes a roller configured to convey the first web and a robot configured to remove the defective label from the first web.

Optionally, the machine includes a peel bar around which the first web is conveyed such that the peel bar is configured to delaminate the defective label from the first web and the robot removes the defective label from the first web. Optionally, the peel bar is configured to delaminate the good-quality label from the first web such that the good-quality label laminates to the first web. Optionally, when the good-quality label is delaminated from the first web, the good-quality label extends across a gap between a first section of the first web and a second section of the first web. Optionally, a label replacement system is configured to dispense a second good-quality label onto the first web in a location the defective label is removed from the first web by the robot. Optionally, the label replacement system includes a peel bar around which a second web with the second good-quality label thereon such that the second good-quality label is delaminated from the second web and laminates onto the second web. Optionally, the robot is also the label replacement system. Optionally, the robot is configured to remove the defective label from the first web, remove another good-quality label from a second web, and place the another good-quality label onto the first web in the location the defective label was removed from the first web. Optionally, the robot includes a gripping member configured to be moved relative to the web and remove the defective label. Optionally, the machine includes an extraction system with a supply web having a plurality of good-quality labels thereon and the robot is configured to remove the defective label from the first web, place a good-quality label in a location the defective label was removed from the first web, place the defective label onto the supply web, and pick up a good-quality label of the plurality of good-quality labels on the supply web. Optionally, the good-quality label is a first good-quality label and the robot is further configured to dispense a second good-quality label onto the first web in a location the defective label is removed from the first web by the robot. Optionally, the gripping member has an engagement surface that is convex and the engagement surface is configured to engage the defective label and a second good-quality label. Optionally, the gripping member includes a plurality of engagement zones through which suction forces are applied to the defective label or the second good-quality label. Optionally, the gripping member includes a suction device at each engagement zone of the plurality of engagement zones that engages the defective label or the second good-quality label. Optionally, an air system generates a vacuum and the gripping member has a plurality of channels that permit suction forces to be applied via engagement zones of the gripping member to the defective label or the second good-quality label. Optionally, the channels are routed internally through a body of the gripping member.

In certain examples, a machine for placing a good-quality label from a first web in a location in which a defective label was located includes a roller configured to convey the first web and a robot configured to dispense the good-quality label onto the first web in the location the defective label is removed from the first web.

Optionally, the robot is further configured to remove the defective label from the first web. Optionally, the machine includes a peel bar around which the first web is conveyed such that the peel bar is configured to delaminate the defective label from the first web and the robot removes the defective label from the first web. Optionally, the peel bar is configured to delaminate the good-quality label from the first web such that the good-quality label laminates to the first web. Optionally, when the good-quality label is delaminated from the first web, the good- quality label extends across a gap between a first section of the first web and a second section of the first web. Optionally, the good-quality label is a first good-quality label and the machine includes a peel bar around which a second web with a second good-quality label thereon such that the second good-quality label is delaminated from the second web and laminates onto the first web. Optionally, the robot is also a label removal system configured to remove the defective label from the first web. Optionally, the robot is configured to remove the defective label from the first web, remove another good-quality label from a second web, and place the another good-quality label onto the first web in the location the defective label was removed from the first web. Optionally, the robot includes a gripping member configured to be moved relative to the web to thereby removed the defective label. Optionally, the machine includes an extraction system with a supply web having a plurality of good-quality labels thereon and the robot is configured to remove the defective label from the first web, place a good-quality label in the location the defective label was removed from the first web, place the defective label onto the supply web, and pick up a good-quality label of the plurality of good-quality labels on the supply web. Optionally, the good-quality label is a first good-quality label and the gripping member has an engagement surface that is convex, and the engagement surface is configured to engage the defective label, the first good-quality label, and/or a second good-quality label. Optionally, the gripping member includes a plurality of engagement zones that are configured to apply suction forces to the defective label or the second good-quality label. Optionally, the gripping member includes a suction device at each engagement zone of the plurality of engagement zones that engage the defective label or the second good-quality label. Optionally, an air system generates a vacuum and the gripping member having a plurality of channels that permit suction forces of the vacuum to be applied by engagement zones of the gripping member to the defective label or the second good-quality label. Optionally, one or more of the channels in the plurality of channels are routed internally through a body of the gripping member.

In certain examples, a machine for removing a defective label from a first web a good-quality label thereon includes a first roller configured to convey the first web, a label removal system configured to remove the defective label from the first web, and a second roller configured to convey a second web such that the second web receives the good-quality label from the first web.

Optionally, the label removal system is a vacuum drum. Optionally, the label removable system is a robot. Optionally, the machine includes a peel bar around which the first web is conveyed such that the peel bar is configured to delaminate the defective label and the good-quality label from the first web. Optionally, the peel bar is configured to delaminate the good-quality label from the first web such that the good-quality label laminates to the second web. Optionally, when the good-quality label is delaminated from the first web, the good-quality label extends across a gap between first web and the second web. Optionally, the machine includes a semi rotary shuttle that is configured to move the second web without changing an upstream web speed and an downstream web speed of the second web.

In certain examples, a method of operating a machine that removes a defective label from a first web includes identifying a defective label on the first web, removing, with a robot, the defective label from the first web, and replacing a good-quality label onto the first web in a location the defective label is removed.

Optionally, the replacing the good-quality label is with the robot. Optionally, the method includes discarding the defective label. Optionally, discarding the defective label is with the robot.

In certain examples, a method of operating a machine that removes a defective label from a first web includes identifying the defective label on the first web, removing the defective label from the first web, and transferring a good-quality label from a first section of the first web to a second section of the first web.

Optionally, the removing the defective label is with a robot. Optionally, the method includes discarding the defective label. Optionally, the discarding the defective label is with a robot.

In certain examples, a method of operating a machine that removes a defective label from a first web includes identifying the defective label on the first web, removing, with a robot, the defective label from the first web, and transferring a good-quality label from the first web to a second web.

Optionally, the removing the defective label is with the robot. Optionally, the method includes discarding the defective label. Optionally, the discarding the defective label is with the robot.

In certain examples, a machine for removing defective labels from a first web containing good-quality labels includes a first roller configured convey the first web, a second roller configured to convey a second web, a peel bar moveable into and between an extended position in which the peel bar is configured to cause the good-quality labels to transfer from the first web to the second web and a retracted position in which the defective labels remain on the first web.

Optionally, an inspection system is configured to sense the defective labels on the first web and a control system that controls movement of the peel bar based on the sensed defective labels.

In certain examples, a machine for removing defective labels from a web containing good-quality labels a first peel bar configured to permit the web to be conveyed there along such that the good-quality labels delaminate from the web, extend across a gap adjacent to the first peel bar, and laminate with the web and a label removal system configured to engage and remove the defective labels from the web as the first peel bar causes the defective labels to delaminate from the web. Optionally, the label removal system is a vacuum drum.

In certain examples, a machine for removing defective labels from a web containing good-quality labels includes a plurality of rollers configured to convey the web, an inspection system configured to inspect labels on the web, a control system configured to determine a location of defective labels on the web, and a robot configured to remove the defective labels from the web.

Optionally, the robot includes a wedge that is configured to slide between the defective label and the web to thereby remove the defective label. Optionally, the machine includes an extraction system and the robot is configured to place the defective label in the extraction system. Optionally, the machine includes a supply roll with replacement good-quality labels thereon and the robot is configured to remove a replacement good-quality label when placing the defective label in the extraction system. Optionally, the supply roll includes a supply web from which the replacement good-quality labels are removed and the defective labels are coupled. Optionally, the machine includes a supply roll with replacement good-quality labels and the robot is configured to remove a replacement good-quality label from the supply roll and place the replacement good-quality label on the web in a location the defective label was removed.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A machine for removing a defective label from a first web with a good-quality label thereon, the machine comprising:
a roller configured to convey the first web; and
a robot configured to remove the defective label from the first web.

2. The machine according to claim 1, further comprising a peel bar around which the first web is conveyed such that the peel bar is configured to delaminate the defective label from the first web and the robot removes the defective label from the first web.

3. The machine according to claim 2, wherein the peel bar is configured to delaminate the good-quality label from the first web such that the good-quality label laminates to the first web.

4. The machine according to claim 3, wherein when the good-quality label is delaminated from the first web, the good-quality label extends across a gap between a first section of the first web and a second section of the first web.

5. The machine according to claim 1, further comprising a label replacement system that is configured to dispense a second good-quality label onto the first web in a location the defective label is removed from the first web by the robot.

6. The machine according to claim 5, wherein the label replacement system includes a peel bar around which a second web with the second good-quality label thereon such that the second good-quality label is delaminated from the second web and laminates onto the second web.

7. The machine according to claim 5, wherein the robot is also the label replacement system.

8. The machine according to claim 7, wherein the robot is configured to remove the defective label from the first web, remove another good-quality label from a second web, and place the another good-quality label onto the first web in the location the defective label was removed from the first web.

9. The machine according to claim 1, wherein the robot includes a gripping member configured to be moved relative to the web and remove the defective label.

10. The machine according to claim 9, further comprising an extraction system with a supply web having a plurality of good-quality labels thereon, and wherein the robot is configured to:
remove the defective label from the first web;
place a good-quality label in a location the defective label was removed from the first web;
place the defective label onto the supply web; and
pick up a good-quality label of the plurality of good-quality labels on the supply web.

11. The machine according to claim 1, wherein the good-quality label is a first good-quality label, and wherein the robot is further configured to dispense a second good-quality label onto the first web in a location the defective label is removed from the first web by the robot.

12. The machine according to claim 9, wherein the gripping member has an engagement surface that is convex, and the engagement surface is configured to engage the defective label and a second good-quality label.

13. The machine according to claim 12, wherein the gripping member includes a plurality of engagement zones through which suction forces are applied to the defective label or the second good-quality label.

14. The machine according to claim 13, wherein the gripping member includes a suction device at each engagement zone of the plurality of engagement zones that engages the defective label or the second good-quality label.

15. The machine according to claim 14, further comprising an air system that generates a vacuum, and the gripping member having a plurality of channels that permit suction forces to be applied via engagement zones of the gripping member to the defective label or the second good-quality label.

16. The machine according to claim 15, wherein the channels are routed internally through a body of the gripping member.

17-60. (canceled)
